(19) United States
(12) Patent Application Publication
(10) Pub. No.: US 2024/0019806 A1
(43) Pub. Date: Jan. 18, 2024

(54) PRINTED MATERIAL, IMAGE FORMING APPARATUS, AND DATA ACQUISITION DEVICE

(71) Applicant: Ricoh Company, Ltd., Tokyo (JP)

(72) Inventors: Hiroki ATARI, Kanagawa (JP); Masato TANAKA, Shizuoka (JP); Keiji KUNIMI, Kanagawa (JP); Rumi MIYAZAKI, Tokyo (JP)

(73) Assignee: Ricoh Company, Ltd., Tokyo (JP)

(21) Appl. No.: 18/372,132

(22) Filed: Sep. 25, 2023

Related U.S. Application Data
(62) Division of application No. 17/406,083, filed on Aug. 19, 2021.

(30) Foreign Application Priority Data
Sep. 16, 2020 (JP) 2020-155632
Mar. 31, 2021 (JP) 2021-059408

(51) Int. Cl. G03G 15/00; G06K 19/06; G06K 7/14; B42D 25/382

(52) U.S. Cl. CPC G03G 15/5087; G03G 15/6585; G06K 19/06037; G06K 7/1417; B42D 25/382

(57) ABSTRACT

A printed material, an image forming apparatus, and a data acquisition device. The printed material includes a printed confidential information image visible under a special condition, and an information image having information on a position of the confidential information image. The image forming apparatus includes an image forming device configured to form an image on a recording medium to form the printed material. The data acquisition device includes circuitry, and the circuitry is configured to acquire confidential information from the confidential information image on the printed, specify the position of the confidential information image from the information image, and display position information of the confidential information image.

### CROSS-REFERENCE TO RELATED APPLICATIONS

This patent application is a Divisional of U.S. application Ser. No. 17/406,083, filed Aug. 19, 2021, which is based on and claims priority pursuant to 35 U.S.C. § 119(a) to Japanese Patent Application Nos. 2020-155632 and 2021-059408, filed on Sep. 16, 2020, and Mar. 31, 2021, respectively, in the Japan Patent Office, the entire disclosures of each are hereby incorporated by reference herein.

### BACKGROUND

### Technical Field

Embodiments of the present disclosure relate to a printed material, an image forming apparatus, and a data acquisition device.

### Background Art

Conventionally, a printed material on which a confidential information image visible under a special condition is printed is known.

More specifically, a printed material on which a QR code (registered trademark) is formed by transparent infrared absorption toner as the confidential information image. The confidential information is read by reading such a QR code with an infrared light irradiation reader.

### SUMMARY

Embodiments of the present disclosure described herein provide a printed material, an image forming apparatus, and a data acquisition device. The printed material includes a printed confidential information image visible under a special condition, and an information image having information on a position of the confidential information image. The image forming apparatus includes an image forming device configured to form an image on a recording medium to form the printed material. The data acquisition device includes circuitry, and the circuitry is configured to acquire confidential information from the confidential information image on the printed, specify the position of the confidential information image from the information image, and display position information of the confidential information image.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a diagram illustrating a printed material according to embodiments of the present disclosure.

FIG. 2 is a diagram illustrating a printed material on which a confidential information image is formed, according to the related art.

FIG. 3 is a diagram illustrating how a confidential information image is obtained, according to the related art.

FIG. 4 is a diagram illustrating a printed material according to a first modification of the above embodiments of the present disclosure.

FIG. 5 is a diagram illustrating a printed material according to a second modification of the above embodiments of the present disclosure.

FIG. 6 is a diagram illustrating a printed material to which a plurality of arrow images indicating the position of a pair of confidential information images are added along character strings, according to a second modification of the above embodiments of the present disclosure.

FIG. 7 is a diagram illustrating the printed material of FIG. 6 in which character strings indicating the contents of the confidential information of each one of confidential information images are added to the character strings of each one of position-information images.

FIG. 8 is a diagram illustrating a printed material in which a plurality of straight lines radially extending from a pair of confidential information images are added to a pair of position-information images, according to a second modification of the above embodiments of the present disclosure.

FIG. 9 is a diagram illustrating a printed material in which character strings and straight lines are extended in four directions from each confidential information image, according to a second modification of the above embodiments of the present disclosure.

FIG. 10 is a diagram illustrating a printed material in which gradation images are added to each position-information image, according to a second modification of the above embodiments of the present disclosure.

FIG. 11 is a diagram illustrating a printed material according to a third modification of the above embodiments of the present disclosure.

FIG. 12A and FIG. 12B are diagrams each illustrating a printed material according to a fourth modification of the above embodiments of the present disclosure.

FIG. 13 is a diagram illustrating a schematic configuration of a printer according to an embodiment of the present disclosure.

FIG. 14 is a graph illustrating the relation between the number of passed sheets and the refresh amount, according to an embodiment of the present disclosure.

FIG. 15A and FIG. 15B are diagrams each illustrating a plurality of position-information images that are formed according to the refresh amount, according to an embodiment of the present disclosure.

FIG. 16 is a flowchart of the setting of a position-information image, according to embodiments of the present disclosure.

FIG. 17 is a diagram illustrating a printed material in which a position-information image and first and second confidential information images are formed with visible toner, according to embodiments of the present disclosure.

FIG. 18A is an enlarged view of the printed material illustrated in FIG. 17 around the first confidential information image.

FIG. 18B is an enlarged view of the printed material illustrated in FIG. 17 around the second confidential information image.

FIG. 19 is a functional block diagram for displaying a focus mark at a position corresponding to a confidential information image on a printed material displayed on an image display unit of a camera, according to embodiments of the present disclosure.

FIG. 20A to FIG. 20F are diagrams illustrating the transition of an image display unit of a camera, according to embodiments of the present disclosure.

FIG. 21 is a diagram illustrating how a background image conceals a confidential information image, according to an alternative embodiment of the present disclosure.

FIG. 22 is an enlarged view of the printed material illustrated in FIG. 21, around the confidential information image.

FIG. 23 consists of a plurality of diagrams (a) to (c) each illustrating a printed material on which a confidential information image and a plurality of position-information images are formed with general-purpose black toner, according to embodiments of the present disclosure.

FIG. 24 consists of a plurality of diagrams (a) to (d) each illustrating a printed material having a confidential information image formed with IR toner or a confidential information image formed with black toner, according to embodiments of the present disclosure.

FIG. 25 consists of a plurality of diagrams (a) to (c) illustrating the printed materials illustrated in the diagrams (a) to (c) of FIG. 23, where the position-information images are converted into a coded image.

FIG. 26 is a schematic diagram illustrating a background image of Y color toner, M color toner, and C color toner is formed on a black toner image, according to embodiments of the present disclosure.

FIG. 27 is a schematic diagram illustrating a plurality of background images of Y color toner, M color toner, and C color toner are formed on a black toner image, according to embodiments of the present disclosure.

FIG. 28 is a diagram illustrating an image forming apparatus provided with a re-conveyance path, according to embodiments of the present disclosure.

FIG. 29 is a functional block diagram of an information transmission system according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-programmable gate arrays (FPGAs), computers or the like. These terms may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Some embodiments of the present disclosure are described below with reference to the drawings.

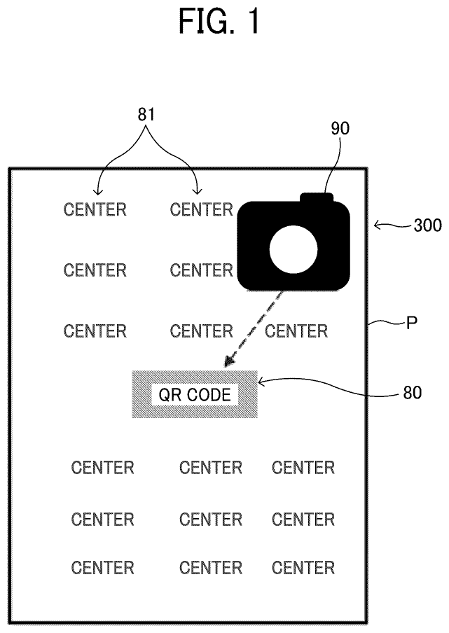

FIG. 1 is a diagram illustrating a printed material 300 according to embodiments of the present disclosure.

As illustrated in FIG. 1, the printed material 300 according to the present embodiment includes a quick response (QR) code (registered trademark) in which confidential information is recorded, and a confidential information image 80 that cannot visually be recognized easily is formed in the center of a sheet of paper P. Moreover, a plurality of position-information images 81 that indicate the positions of the confidential information images 80 are formed on the printed material 300 according to the present embodiment. In a similar manner to the confidential information image the multiple position-information images 81 cannot visually be recognized easily.

The confidential information image 80 and the position-information image 81 are formed of a special-light responsive image forming material. Such a special-light responsive image forming material absorbs the light outside the light within the optical range of visible light, or emits the light within the optical range of visible light by light outside the light within the optical range of visible light. Moreover, such a special-light responsive image forming material reproduces color of the light within the optical range of visible light by light outside the light within the optical range of visible light. The special-light responsive image forming material may be, for example, infrared absorbing toner that has transparency and absorbs infrared light, transparent fluorescent toner that fluoresces when irradiated with ultraviolet light, infrared absorbing ink, and a transparent fluorescent ink that fluoresces when irradiated with ultraviolet light. In the present embodiment, infrared absorbing toner, which may be referred to as an infrared toner) in the following description, is used as the special-light responsive image forming material.

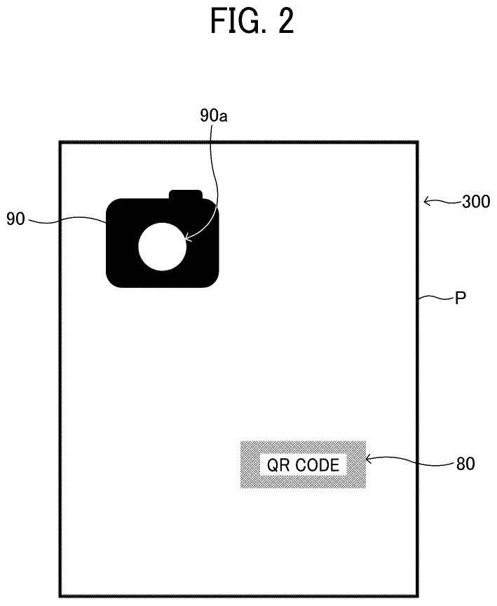

FIG. 2 is a diagram illustrating the printed material 300 on which a confidential information image 80 is formed, according to the related art.

As the confidential information image 80 is formed by IR toner that has transparency, it is difficult to visually recognize with unaided eye at what portion of sheet of paper P the confidential information image 80 is formed under visible light. As known in the art, such a confidential information image 80 can be visually recognized by a captured image captured using the infrared camera 90 that serves as the data acquisition device, and the confidential information is generally read by capturing the confidential information image 80 with the infrared camera 90. The spot size 90a of the infrared camera 90 known in the art is approximately 20 millimeters (mm) in diameter.

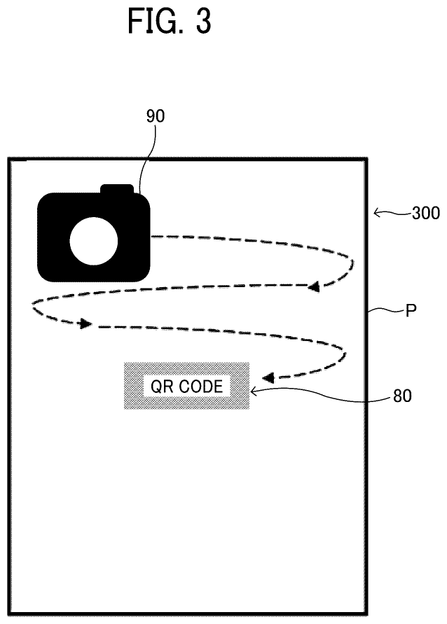

Accordingly, when the confidential information image 80 is formed on a portion of commonly used A4 paper (210 mm×290 mm), for example, the infrared camera 90 is moved to find out the confidential information image 80 as follows. In other words, while viewing an image to be captured through the image display unit of the infrared camera 90, as indicated by the broken line in FIG. 3, the infrared camera 90 is gradually moved downward while moving the infrared camera 90 from the top-left end of the paper in the right and left directions. By so doing, the confidential information image 80 is searched for. In the arrangement described above, it takes time to find the confidential information image 80 from the paper. When the image of entire paper is captured by the infrared camera 90, the number of pixels of the confidential information image 80 is small, and the confidential information image 80 tends to be a blurred image. Accordingly, there are some cases in which the confidential information image 80 cannot be recognized and the confidential information cannot be read from the confidential information image 80.

By contrast, the printed material 300 according to the present embodiment illustrated in FIG. 1 has a plurality of position-information images 81 that indicate the position of the confidential information image 80. Each one of these position-information images 81 is a textual image including a phrase “center” indicating the position at which the confidential information image 80 is formed. In a similar manner to the confidential information image 80, these position-information images 81 are also formed of transparent infrared absorbing toner (IR toner). Accordingly, it is difficult to visually recognize the position-information image 81 with the naked eye or unaided eye, and the position-information image 81 is displayed on the image display unit 97 of the infrared camera 90 and can be visually recognized by imaging any position on the paper surface using the infrared camera 90. As described above, if the position-information image 81 is made an image that can visually be recognized under the special condition that the image is captured by the infrared camera 90, the position-information image 81 can be prevented from being visually recognized under normal visible light. Accordingly, damage to the quality of design of the printed material 300 due to the position-information image 81 can be prevented.

From the text “center” of the position-information image 81 displayed on the image display unit 97 of the infrared camera 90, it can be understood that the confidential information image 80 is located at the center of the paper.

As the spot or captured range of the infrared camera 90 is moved to the center of the paper based on the position information obtained from the position-information image 81, the confidential information image 80 is captured by the infrared camera 90, and the confidential information can be read from the confidential information image 80. As described above, on the printed material 300 according to the present embodiment, the confidential information image 80 can easily be found based on the position-information image 81.

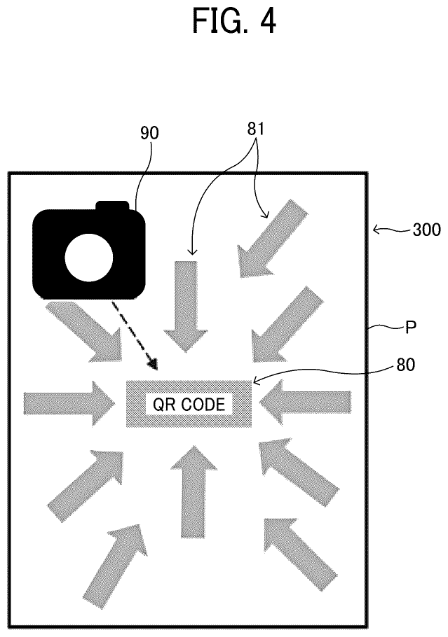

FIG. 4 is a diagram illustrating the printed material 300 according to the first modification of the above embodiments of the present disclosure.

In FIG. 4, a plurality of arrows that indicate the position of the confidential information image 80 are used as the position-information image 81.

Also in the printed material 300 as illustrated in FIG. 4, by moving the spot of the infrared camera 90 in the direction of the arrow of the position-information image 81 reflected in the captured image of the infrared camera 90, the confidential information image 80 can easily be found and the confidential information can be read.

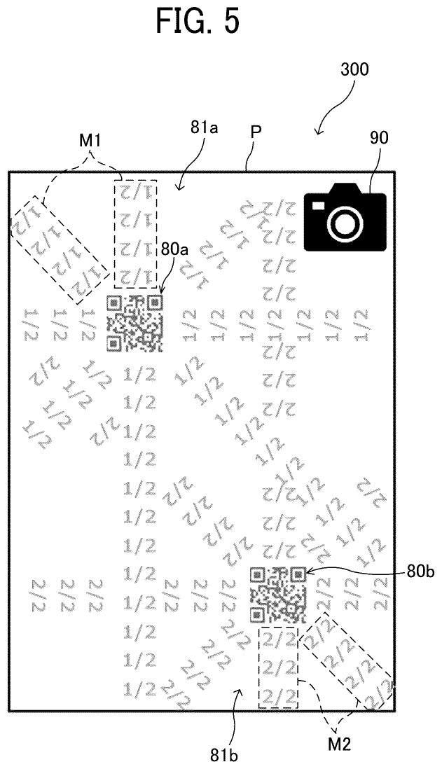

FIG. 5 is a diagram illustrating the printed material 300 according to the second modification of the above embodiments of the present disclosure.

The printed material 300 as illustrated in FIG. 5 has two confidential information images 80a and 80b. Each one of the two confidential information images 80a and 80b is made of a QR code, and each QR code is formed of IR toner with transparency. Moreover, the printed material 300 has a first position-information image 81a indicating the position of the first confidential information image 80a formed on the top left of the paper surface in the drawing and a second position-information image 81b indicating the position of the second confidential information image 80b formed on the bottom right of the paper surface in the drawing. The first position-information image 81a and the second position-information image 81b are formed of IR toner having transparency.

The first position-information image is constituted by a plurality of character strings M1 in which a plurality of textual images of “1/2” are linearly arranged, and these character strings M1 are radially arranged around the first confidential information image 80a.

The second position-information image includes a plurality of character strings M2 in which a plurality of textual images “2/2” are linearly arranged, and these character strings M2 are radially arranged around the second confidential information image 80b.

In the printed material 300 illustrated in FIG. 5, it can be understood that there are two confidential information images 80 from the textual images “1/2” and “2/2” of the multiple position-information images 81a and 81b displayed on the image display unit of the infrared camera 90. As a result, the confidential information can be prevented from being left unread and not acquired.

Moreover, the spot of the infrared camera 90 is moved in a direction in which the first character strings M1 become dense based on the first position-information image 81a displayed on the image display unit of the infrared camera 90. Due to such a configuration, the infrared camera 90 can capture the first confidential information image 80a and read the confidential information from the first confidential information image 80a.

Further, the spot of the infrared camera 90 is moved in a direction in which the second character strings M2 become dense based on the second position-information image 81b displayed on the image display unit of the infrared camera 90. Due to such a configuration, the infrared camera 90 can capture the second confidential information image 80b and read the confidential information from the second confidential information image 80b. Also in the second modification of the above embodiments of the present disclosure, each one of the confidential information images 80a and 80b can easily be found based on the multiple position-information images 81.

FIG. 6 is a diagram illustrating the printed material 300 to which a plurality of arrow images indicating the position of a pair of confidential information images 80 are added along character strings, according to the second modification of the above embodiments of the present disclosure.

As a result, the direction in which the spot of the infrared camera 90 is moved can be easily figured out from the arrow image of the character string displayed on the image display unit of the infrared camera 90, and the confidential information image can further easily be found.

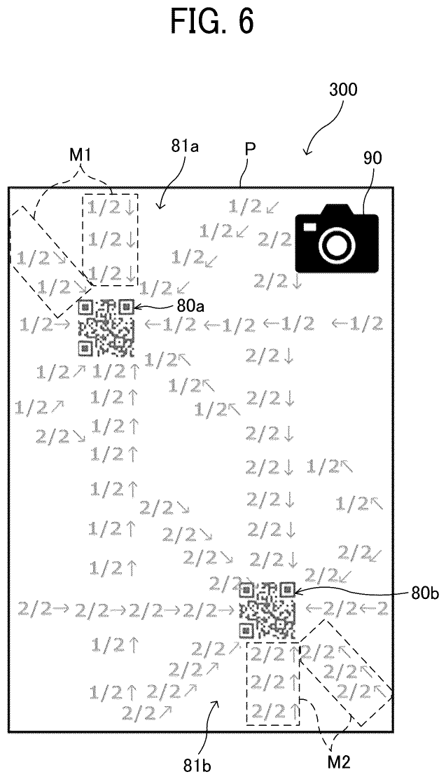

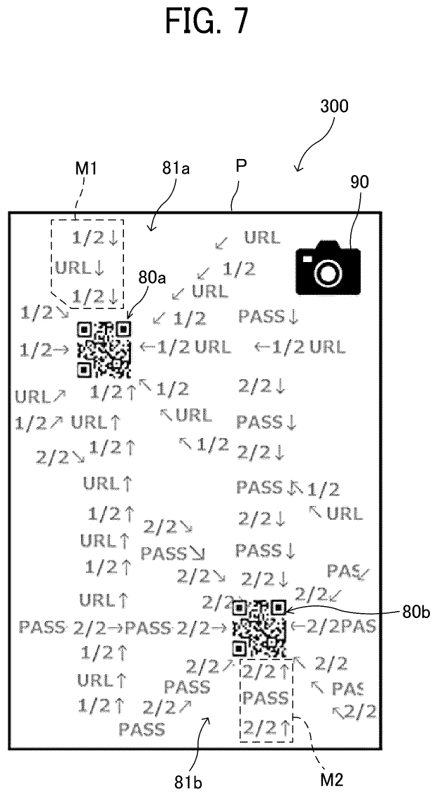

FIG. 7 is a diagram illustrating the printed material 300 of FIG. 6 in which character strings indicating the contents of the confidential information of each one of the confidential information images 80a and 80b is added to the character strings of each one of the position-information images 81a and 81b.

As illustrated in FIG. 7, each character string of each position-information image 81a, 81b may have a character string indicating the content of the confidential information of the confidential information image. In FIG. 7, the URL information is recorded as the confidential information in the first confidential information image 80a, and the PASS code that is used to access the above website of the URL information is recorded as the confidential information in the second confidential information image 80b. The first position-information image 81a has a textual image of “URL” in the character string M1 as information indicating the content of the confidential information. On the other hand, the second position-information image 81b has a textual image of “PASS” in the character string M2 as information indicating the content of the confidential information.

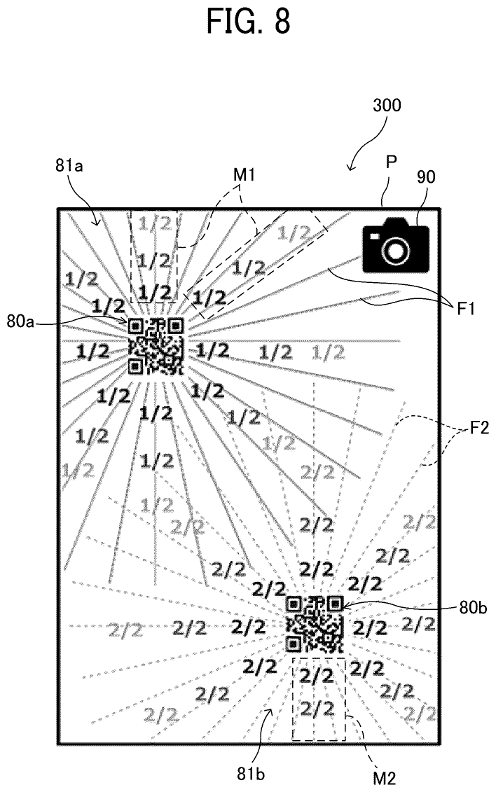

FIG. 8 is a diagram illustrating the printed material 300 in which a plurality of straight lines F1 and F2 radially extending from the confidential information images 80a and 80b are added to the position-information images 81a and 81b, according to the second modification of the above embodiments of the present disclosure.

In the printed material 300 illustrated in FIG. 8, the multiple straight lines F1 that are drawn for the first position-information image 81a are solid lines, and the multiple straight lines F2 that are drawn for the second position-information image 81b are broken lines. Further, in the printed material 300 illustrated in FIG. 8, the image density of the character strings M1 and M2 is reduced as the distance from the confidential information image increases.

In FIG. 8, the spot of the infrared camera 90 is moved in a direction in which the straight lines F1 become dense and in a direction in which the first character strings M1 become darker. Due to such a configuration, the infrared camera 90 can capture the first confidential information image 80a and read the confidential information from the first confidential information image 80a. Moreover, by moving the spot of the infrared camera 90 in a direction in which the multiple straight lines F2 become dense and in a direction in which the multiple second character strings M2 become darker, the second confidential information image 80b can be captured by the infrared camera 90, and the confidential information can be read from the second confidential information image 80b.

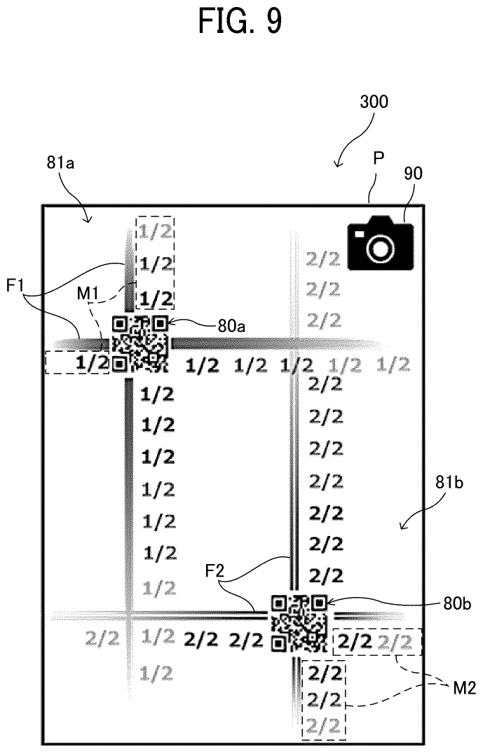

FIG. 9 is a diagram illustrating the printed material 300 in which character strings and straight lines are extended in four directions from each one of the confidential information images 80, according to a second modification of the above embodiments of the present disclosure.

In the printed material 300 as illustrated in FIG. 9, the multiple straight lines F1 that are drawn for the first position-information image 81a are thick lines, and the multiple straight lines F2 that are drawn for the second position-information image 81b are double lines. Further, in the printed material 300 as illustrated in FIG. 9, the image density of each of the character strings M1 and M2 and the straight lines F1 and F2 is reduced as the distance from the corresponding confidential information image increases.

In FIG. 9, by moving the spot of the infrared camera 90 in a direction in which the first character strings M1 and the straight lines F1 become dense or darker, the first confidential information image 80a can be captured by the infrared camera 90, and confidential information can be read from the first confidential information image 80a. Moreover, by moving the spot of the infrared camera 90 in a direction in which the second character strings M2 and the straight lines F2 become dense or darker, the second confidential information image 80b can be captured by the infrared camera 90, and the confidential information can be read from the second confidential information image 80b.

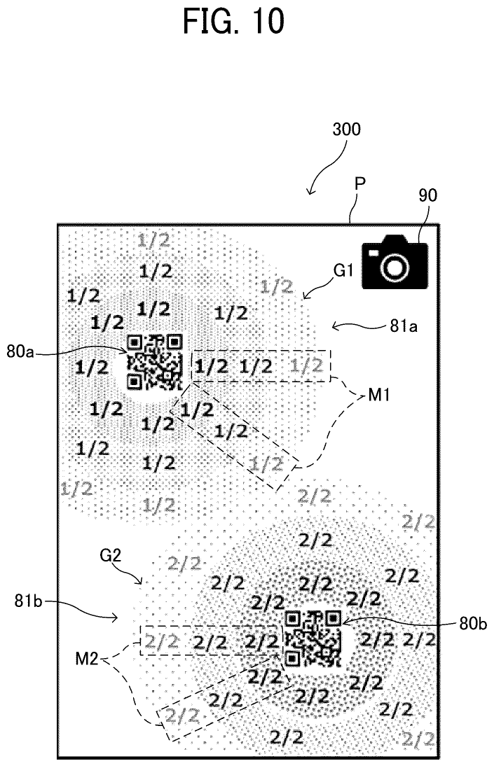

FIG. 10 is a diagram illustrating the printed material 300 in which gradation images G1 and G2 are added to the position-information images 81a and 81b, according to the second modification of the above embodiments of the present disclosure.

The gradation images G1 and G2 are circles that become thinner as they are away from the confidential information image. Also in FIG. 10, the image density of each of the character strings M1 and M2 decreases as the distance from the confidential information image increases.

In FIG. 10, the spot of the infrared camera 90 is moved in a direction in which the first character strings M1 and the gradation images G1 displayed on the infrared camera 90 become darker. Such a configuration allows the infrared camera 90 to capture the first confidential information image 80a and to read the confidential information from the first confidential information image 80a. Moreover, the spot of the infrared camera 90 is moved in a direction in which the second character strings M2 and the gradation images G2 become dark. Accordingly, the second confidential information image 80b can be captured by the infrared camera 90, and the confidential information can be read from the second confidential information image 80b.

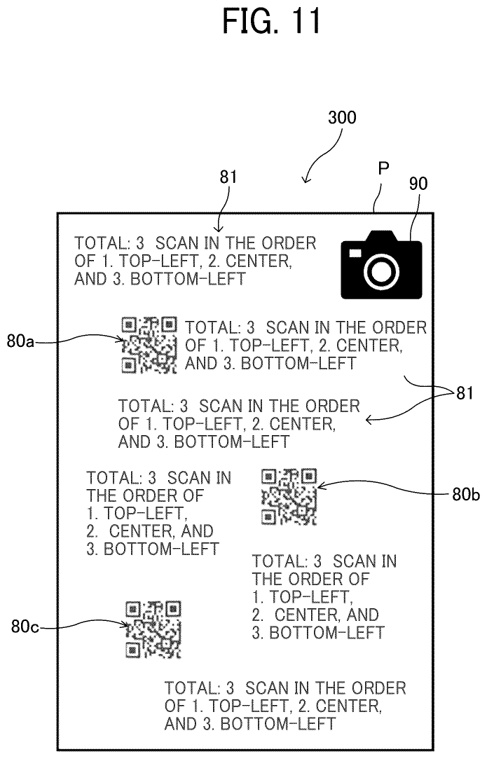

FIG. 11 is a diagram illustrating the printed material 300 according to a third modification of the above embodiments of the present disclosure.

The position-information image of the printed material 300 according to the third modification of the above embodiments of the present disclosure is a textual image indicating the number of confidential information images, the position of the confidential information image, and the order in which the confidential information images are to be read.

From the position-information image 81 displayed on the image display unit of the infrared camera 90, it can be understood that there are three confidential information images, that the confidential information images are at the top left, in the center, and at the bottom left of the paper, and that the order in which the confidential information images are to be read is from the top left to the center, and then to the bottom left.

The size of each QR code needs to be increased in accordance with the amount of information. When the size is too large, it is difficult for the infrared camera 90 to read the information. Accordingly, when the amount of information is large, the information may be divided into a plurality of QR codes and the QR codes may be read in a certain order such that desired information can be acquired.

As illustrated in FIG. 11, the position-information image 81 includes the information on the order in which the confidential information images are to be read in addition to the position information of the confidential information and the number of items of confidential information. As a result, the multiple confidential information images can be read in a desired order, and the confidential information can be acquired accurately from these confidential information images.

Giving the order in which the multiple confidential information images are to be read as described above does not only increase the amount of information but also improves the confidentiality of the information.

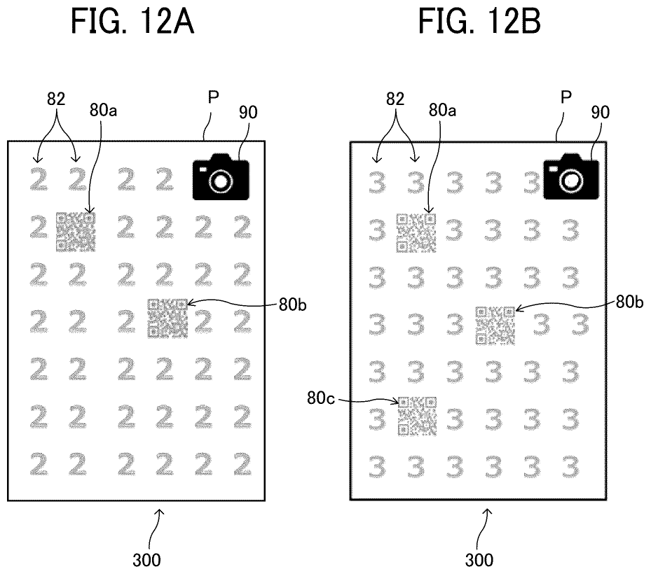

FIG. 12A and FIG. 12B are diagrams each illustrating the printed material 300 according to a fourth modification of the above embodiments of the present disclosure.

The printed material 300 according to the fourth modification of the above embodiments of the present disclosure includes a plurality of confidential information images and a number information image 82 that indicates the number of confidential information images. FIG. 12A illustrates a case in which two confidential information images 80a and 80b are present on the printed material 300, and FIG. 12B illustrates a case in which three confidential information images 80a, 80b, and 80c are present on the printed material 300. The number information images 82 are numbers of 6 to 12 points, and are made of transparent IR toner and are arranged at equal intervals over the entire paper.

According to the fourth modification of the above embodiments of the present disclosure, the number of the confidential information images 80 can be figured out from the number indicated by the number information image 82 displayed on the monitor of the infrared camera 90. As a result, the confidential information can be prevented from being left unread and not acquired.

An image forming apparatus capable of printing the printed material 300 on which, for example, the confidential information image 80 and the position-information image 81 are formed with transparent IR toner, according to the present embodiment, is described below.

The image forming apparatus is not particularly limited as long as it forms, for example, the confidential information image 80 and the position-information image 81 on a sheet using IR toner that forms, for example, the confidential information image 80 and the position-information image 81. Accordingly, in addition to the printer 200, the image forming apparatus may be a copier or a facsimile on its own, or a multifunction peripheral having at least two functions of the printer 200, the copier, the facsimile, and the scanner.

In the following description, reference signs are used for some components of the apparatus according to the present embodiment. In particular, yellow toner, magenta toner, and cyan toner may be referred to as Y (Y color toner), M (M color toner), and C (C color toner), respectively.

Firstly, the overall configuration and operation of the image forming apparatus will be described.

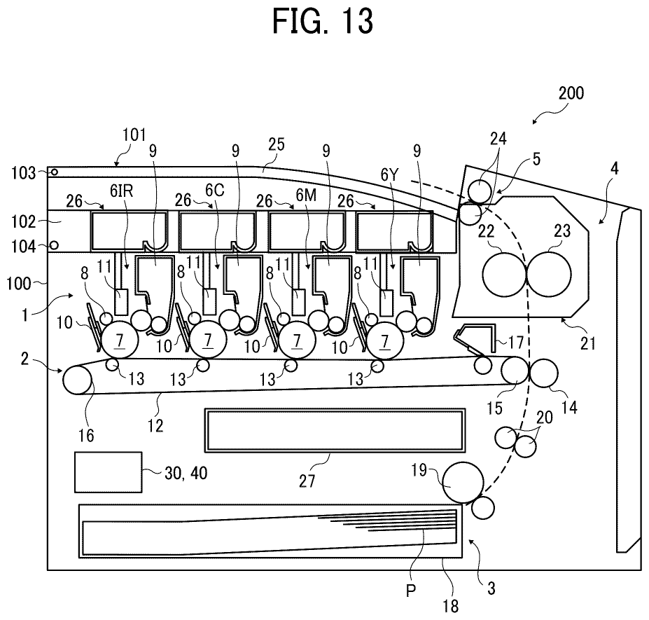

FIG. 13 is a diagram illustrating a schematic configuration of a printer 200 that serves as an image forming apparatus, according to the present embodiment.

The printer 200 according to the present embodiment includes, for example, an image forming device 1, a transfer unit 2, a recording medium supply unit 3, a fixing device 4, a recording medium ejection unit 5, a controller 30, and an image formation controller 40.

The image forming device 1 is provided with four processing units 6Y, 6M, 6C, and 6IR that serve as a set of image forming units. The configuration or structure of the four processing units 6Y, 6M, 6C, and 6IR is equivalent to each other except that different types of toner are used in each one of the four processing units 6Y, 6M, 6C, and 6IR. In the present embodiment, a processing unit that uses black (K) toner is not provided as a part of the image forming units. Accordingly, a color image or a monochrome image is formed using only Y color toner, M color toner, and C color toner. A processing unit that uses K toner may be added as a part of the image forming units. However, such a configuration could be disadvantageous because size of the apparatus tends to increase.

The processing unit 6IR that uses IR toner may be configured in a detachable manner, or the printer 200 according to the present embodiment may be configured such that a processing unit that uses K toner may be installed instead of the processing unit that uses the IR toner. In such a configuration, a processing unit of K toner may be mounted when an image is to be formed without using the IR toner. By so doing, a color image or a monochrome image can be formed using Y color toner, M color toner, C color toner, and K color toner.

Alternatively, all the processing units of the image forming apparatus may be made removable, and the positions at which these processing units are installed may be interchanged with each other. In such a configuration, the positions of the processing units that use IR toner may be interchanged to switch the relative positions of the IR toner image and the multiple color toner image, i.e., the relative positions of the IR toner image and the multiple color toner image in the toner-image stacking direction, on a recording medium on an as-needed basis.

In the present embodiment, each one of the four processing units 6Y, 6M, 6C, and 6IR includes, for example, a photoconductor 7 that serves as a latent-image bearer and bears a latent image, and a charging roller 8 that serves as a charger and evenly charges the surface of the photoconductor 7. Moreover, each one of the four processing units 6Y, 6M, 6C, and 6IR includes, for example, a developing device 9 that serves as a developing unit and develops a latent image on the surface of the photoconductor 7, and a photoconductor cleaner 10 that serves as a latent-image bearer cleaning unit and cleans the surface of the photoconductor 7. A plurality of exposure devices 11 that serve as latent image forming units and form latent images on the surfaces of the photoconductors 7 are arranged at positions facing the multiple photoconductors 7. In the present embodiment, a light-emitting diode (LED) unit is used as the exposure device 11. However, no limitation is indicated thereby, and a laser-beam scanning exposure device that uses laser diodes may be adopted.

In the transfer unit 2, a seamless intermediate transfer belt 12 that serves as an intermediate transferor and is a belt onto which the toner image on the photoconductor 7 is transferred, and a plurality of primary transfer rollers 13 that serve as primary transfer units and primarily transfer the image on the photoconductor 7 onto an intermediate transfer belt 12 are arranged. Moreover, in the transfer unit 2, a secondary transfer roller 14 that serves as a secondary transfer unit and secondarily transfers the toner image that is transferred to the intermediate transfer belt 12 to the recording medium, and a belt cleaner 17 that serves as an intermediate transferor cleaning unit and cleans the outer circumferential surface of the intermediate transfer belt 12 are arranged.

The intermediate transfer belt 12 is stretched by a drive roller 15 and at least one driven roller 16, and goes round as the drive roller 15 rotates on the axis. The multiple primary transfer rollers 13 are arranged so as to press the intermediate transfer belt 12 against the multiple photoconductors 7. Due to such a configuration, a plurality of primary transfer nips at which the images on the multiple photoconductors 7 are transferred onto the intermediate transfer belt 12 are formed at a plurality of contact portions where the intermediate transfer belt 12 contacts the multiple photoconductors 7. On the other hand, the secondary transfer roller 14 is arranged so as to contact a portion of the intermediate transfer belt 12 that is wrapped around the drive roller 15. Due to such a configuration, a secondary transfer nip at which the image on the intermediate transfer belt 12 is transferred onto the recording medium is formed at a contact portion where the intermediate transfer belt 12 contacts the secondary transfer roller 14 through the recording medium.

The recording medium supply unit 3 is provided with a sheet tray 18 that serves as recording medium storage, a paper feeding roller pair 19 that serves as a recording medium feeding unit, and a timing roller pair 20 that serves as a recording medium conveyance unit. The sheet tray 18 accommodates sheets of paper P that serve as recording media. The paper feeding roller pair 19 feeds the paper P from the sheet tray 18. The timing roller pair 20 conveys the sheet of paper P fed by the paper feeding roller 19 to the secondary transfer nip at a certain timing Note also that the recording medium may be, for example, an overhead projector (OHP) sheet, an OHP film, and a fabric in addition to a sheet of paper. In addition to plain paper, the sheet of paper may be other various kinds of sheets including, for example, a cardboard, a postcard, an envelope, thin paper, coated paper, art paper, tracing paper, and Japan paper whose surface is uneven and not very smooth.

In the fixing device 4, a fixing device 21 that serves as a fixing unit and fixes an image onto the sheet of paper P is arranged. The fixing device 21 includes, for example, a fixing roller 22 that serves as a fixing unit and is heated by a heat source such as a heater, and a pressure roller 23 that serves as a pressurizer and is pressed against the fixing roller 22 with predetermined level of pressure to form a fixing nip.

In the recording medium ejection unit 5, an output roller pair 24 that serves as a recording medium ejection unit and ejects the sheet of paper P that is conveyed through the fixing device 21 to the outside of the apparatus, and an output tray 25 that serves as a recording medium container in which the sheet of paper P ejected through the output roller pair 24 is held are arranged.

The controller 30 is in charge of the overall control of the printer 200, and performs image processing on the image data input from, for example, a personal computer or a reading device such as a scanner.

The image formation controller 40 controls the image-forming operation performed by each element of the printer 200 such as the image forming device 1, the transfer unit 2, the recording medium supply unit 3, the fixing device 4, and the recording medium ejection unit 5, under control of the controller 30.

In addition to the above multiple elements as described above, the printer 200 according to the present embodiment is provided with a plurality of toner cartridges 26 that serve as a granular material container in which a granular material, i.e., toner in the present embodiment, used to form an image is stored. Each one of the multiple toner cartridges 26 stores the toner of the color same as the color of the toner inside the corresponding one of the multiple developing devices 9, and the toner cartridge 26 supplies the developing device 9 with the toner when the amount of the toner inside the corresponding one of the multiple developing devices 9 runs below a predetermined amount. Furthermore, the printer 200 according to the present embodiment is provided with a waste-toner container 27, which serves as another granular material container, in addition to the toner cartridge 26. The waste-toner container 27 stores the waste toner retrieved by the belt cleaner 17 or the photoconductor cleaner 10.

As illustrated in FIG. 13, the printer 200 according to the present embodiment is provided with a cover 101 used to open and close the upper side of a housing 100 of the image forming apparatus. The cover 101 is pivotable in the up-and-down directions around a rotation axis 103 provided for the housing 100 of the image forming apparatus. Under the cover 101, a container holder 102 is arranged in which four toner cartridges 26 can be stored in a removable manner. The container holder 102 is pivotable in the up-and-down directions around another rotation axis 104 provided for the housing 100 of the image forming apparatus.

In the present embodiment, the processing unit 6IR that uses IR toner is arranged most downstream in the direction of travel of the intermediate transfer belt 12, and the processing units 6Y, 6M, and 6C that use color toner are arranged upstream from the processing unit 6IR. This is because an IR toner image that is made of IR toner, which may be referred to as a toner image in the following description, will be formed on the recording medium side compared with the color toner images composed of Y color toner, M color toner, and C color toner. In other words, the Y toner image, the M toner image, the C toner image, and the IR toner image are stacked on top of each other on the intermediate transfer belt 12 in the order listed from the belt side. However, when the secondarily transfer is complete, the IR toner image, the C toner image, the M toner image, and the Y toner image are stacked on top of each other in the order listed from the recording medium side.

As an IR toner image is formed closer to the recording medium than the color toner image, the IR toner image is hidden by the color toner image and the visibility is reduced, and the confidentiality of the IR toner image can easily be secured. However, no limitation is indicated thereby, and the relative positions of the IR processing unit 6IR that uses IR toner and the processing units 6Y, 6M, and 6C that use color toner may be adjusted as desired. As described as above, when the positions at which these processing units 6Y, 6M, 6C, and 6IR are installed are configured to be interchangeable with each other, the position of the processing unit that uses IR toner can be changed as desired.

The basic operation of the printer 200 according to the present embodiment is described below.

When an image forming operation is started, the multiple photoconductors 7 are driven to rotate, and the surfaces of the photoconductors 7 are evenly charged to a predetermined polarity by the multiple charging rollers 8. Subsequently, the exposure devices 11 irradiate the electrically-conductive surfaces of the multiple photoconductors 7 with a laser beam based on the image data input from, for example, a personal computer or a reading device such as a scanner. Accordingly, an electrostatic latent image is formed.

The latent image that is formed on each one of the photoconductors 7 is single-color image obtained by separating a desired full-color image into a plurality of color images of Y, M, and C. More specifically, the input image data is converted and decomposed into YCM color data to generate single-color image data using a color conversion and decomposition table with which the color data of the input image, for example, red, green, and blue (RGB) or yellow, cyan, and magenta (YCM), is converted and decomposed into color data (yellow, cyan, or magenta (YCM)) for the printer 200 according to the present embodiment, and the multiple exposure devices 11 that correspond to the yellow, cyan, and magenta (YCM) colors, respectively, form the latent image of each color on the corresponding one of the multiple photoconductors 7, based on the image data in YCM colors.

In the present embodiment, an IR image is specified by an application on a personal computer as input image data, and IR image data is generated from, for example, the specified input image data. Further, an IR image may be specified by a printer driver on a personal computer. The exposure device 11 for IR images forms an IR latent image, based on the IR image data, on one of the photoconductors 7 that corresponds to the processing unit 6IR that uses IR toner.

The multiple latent image of Y color, C color, M color, or IR that is formed on each one of the photoconductors 7 is supplied with toner from the corresponding one of the developing devices 9, and is developed as toner image of Y color, C color, M color, or IR. The toner images that are formed on the multiple photoconductors 7 are sequentially transferred onto the rotating intermediate transfer belt 12 by superimposing multiple images on top of one another. More specifically, once one of the toner images on the photoconductor 7 is conveyed and reaches the position of the primary transfer nip, the toner images on the multiple photoconductors 7 are sequentially transferred onto the intermediate transfer belt 12 by the transfer electric field formed as a predetermined level of voltage is applied the primary transfer roller 13. Due to the configurations and structure as described above, a full-color toner image (visible image) composed of Y color toner, C color toner, and M color toner and an IR toner image (invisible image) composed of IR toner are formed on the surface of the intermediate transfer belt 12. Some of the toner that failed to be transferred to the intermediate transfer belt 12 and remains on each one of the photoconductors 7 is removed by the corresponding one of the photoconductor cleaners 10.

Once the image-forming operation starts, the paper feeding roller 19 starts rotating, and the sheet of paper P is fed from the sheet tray 18. The timing roller pair temporarily halts the sheet of paper P fed through the paper feeding roller pair 19. Thereafter, the timing roller pair 20 starts rotating at a prescribed timing and starts conveying the sheet of paper P to the secondary transfer nip at a timing when the full color toner image formed on the intermediate transfer belt 12 reaches the secondary transfer nip.

When the sheet of paper P is transferred onto the secondary transfer nip, a predetermined level of voltage is applied the secondary transfer roller 14. Accordingly, a transfer electric field is formed at the secondary transfer nip, and the toner image on the intermediate transfer belt 12 is transferred onto the sheet of paper P all at once due to the electric field formed at the secondary transfer nip. In so doing, the residual toner that is left on the intermediate transfer belt 12 is removed by the belt cleaner 17.

The sheet of paper P is then conveyed to the fixing device 21, and the toner image is fixed to the sheet of paper P as heated and pressurized by the fixing roller 22 and the pressure roller 23. Then, the sheet of paper P is ejected to the outside of the apparatus by the output roller pair 24, and is placed on the output tray 25.

The above description relates to an image forming operation when a full-color image is formed on a recording medium. However, no limitation is indicated thereby, and an image may be formed using any one of the four processing units 6Y, 6M, 6C, and 6IR. Alternatively, an image may be formed using two or three of the four processing units 6Y, 6M, 6C, and 6IR.

The confidential information image 80 and either one of the position-information image 81 and the number information image 82 are generated by application software on a personal computer, and these images are designated as IR images. As a result, the printed material 300 as illustrated in FIG. 1 to FIG. 12 can be obtained.

The printer 200 may automatically generate the position-information image 81 or the number information image 82 to obtain the printed material 300 as illustrated in FIG. 1 to FIG. 12. More specifically, when the confidential information image 80 is designated as the IR image through the printer driver on a personal computer, a selection screen that is used to select whether or not to generate, for example, the position-information image 81 is displayed on the screen of the personal computer. When it is determined that, for example, the position-information image 81 is to be generated, one of a plurality of position-information image patterns or one of a plurality of number information image patterns as illustrated in FIG. 1 to FIG. 12 is selected. The confidential information image 80 designated as the selected IR image and the position-information image 81 or the selected number information image 82 are sent to the printer 200 as the IR image data.

On the PC side, the position of the specified confidential information image 80 is specified, the position-information image 81 is automatically generated based on the specified confidential information image 80 and the position-information image pattern specified by user, and the generated position-information image is transmitted to the printer 200 as IR image data. Alternatively, a position-information image is automatically generated by the printer 200 based on the data of the position-information image pattern received from the PC and the position information of the confidential information image 80.

Moreover, when the consumption of toner in the developing device is small, the amount of deteriorated old toner remaining in the developing device increases. When the amount of the old toner increases, image unevenness and wormholes tend to occur, and the image quality deteriorates. Accordingly, in order to prevent such deterioration of image quality, the printer 200 performs refresh control in which old toner in the developing device 9 is discharged at a prescribed timing and is replaced with new toner to maintain the freshness of toner.

FIG. 14 is a graph illustrating the relation between the number of passed sheets and the refresh amount, according to the present embodiment.

The refresh amount, which is the amount of toner to be discharged from the developing device in order to refresh the toner in the developing device 9, is determined based on the amount of toner consumption in the developing device 9. As known in the art, the amount of toner consumption can be obtained from, for example, the area of image in view of the mileage of the developing device. However, no limitation is intended thereby, and the amount of toner consumption may be obtained from any kinds of measurement as long as it indicates the amount of toner consumption. When the obtained amount of toner consumption is less than a certain threshold value, a refresh amount, i.e., the area of image required for performing toner refresh, is obtained. The obtained refresh amount is accumulated. On the other hand, when the amount of toner consumption exceeds a certain threshold value, the refresh consumption amount is calculated, and the calculated refresh consumption amount is subtracted from the accumulated refresh amount. Once the accumulated refresh amount reaches a discharge execution threshold H, the refresh control is executed and the refresh amount is refreshed to 0.

As known in the art, the threshold value at which the refresh amount is counted up is a consumption amount corresponding to 2% to 3% of an image area. However, as the optimum threshold value varies depending on the image forming optical system or the toner, it is desired that the refresh amount be controlled to an optimum value for the system.

When the accumulated refresh amount reaches the discharge execution threshold H, the refresh control is executed. When the refresh control is executed, a latent image pattern having a width corresponding to the accumulated refresh amount is formed on the surface of the photoconductor 7. As the toner in the developing device 9 is adhered to the latent image pattern and is developed, the old toner in the developing device 9 is discharged and the toner in the developing device 9 is refreshed. The developed image is removed by a photoconductor cleaner 10 and turns to waste toner.

As known in the art, the frequency of use and the amount of use of IR toner are small. For this reason, the deteriorated old toner tends to accumulate in the developing device 9IR. Accordingly, with respect to the IR toner, the above-described refresh control is likely to be performed, and the IR toner is often wasted as waste toner.

In order to reduce the amount of the IR toner that serves as the waste toner by such refresh control, the position-information image 81 to be formed on the sheet may be determined according to the refresh amount of the IR toner. As a result, the old IR toner which originally becomes waste toner can be effectively utilized. In such cases, for example, when it is determined that the position-information image 81 is to be generated through the printer driver, the printer generates the position-information image 81 based on the refresh amount of the IR toner.

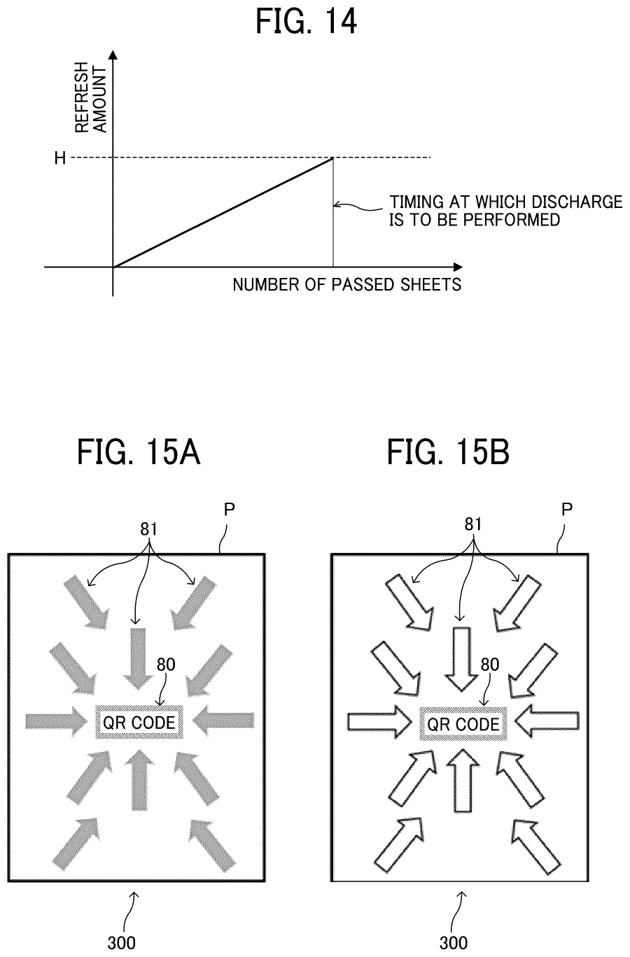

FIG. 15A and FIG. 15B are diagrams each illustrating a plurality of position-information images 81 that are formed according to the refresh amount, according to the present embodiment.

For example, when an image including the confidential information image is to be formed, the cumulative refresh amount is checked. When the cumulative refresh amount is less than the preset value, there is almost no old toner in the developing device 9IR. Accordingly, as illustrated in FIG. 15B, the printer 200 forms the position-information image 81 composed of the arrow image of only the edge to prevent wasteful IR toner consumption. On the other hand, when the cumulative refresh amount is equal to or larger than the preset value, the printer 200 forms a position-information image 81 including a solid-fill arrow image as illustrated in FIG. 15A. As a result, the amount of the IR toner consumed is increased, and the old toner in the developing device 9 is discharged.

The printer 200 may adjust the amount of IR toner consumption by changing the image density of the position-information image 81 including the arrow image according to the accumulated refresh amount. The image forming condition of at least one of the developing bias and the laser diode (LD) power (exposure value) of the exposure device to be emitted to the photoconductor 7IR may be changed to adjust the image density of the position-information image 81. When the cumulative refresh amount is large, the image density is increased to increase the consumption amount of the IR toner so that the old toner in the developing device is discharged. On the other hand, when the cumulative refresh amount is small, the image density is reduced to reduce the consumption of the IR toner.

Further, the IR amount of toner consumption may be adjusted by changing the number of arrow images, changing the thickness of the arrow, or changing the position-information image to the textual image illustrated in FIG. 1 according to the accumulated refresh amount. When there are a plurality of confidential information images, any one of the position-information images illustrated in FIG. 5 to FIG. 11 may be adopted in accordance with the refresh amount to adjust the IR amount of toner consumption.

The printer 200 may form the position-information image 81 based on the refresh amount after the job is completed. The refresh amount after the end of the job is calculated from the refresh amount at the start of the print job, the travel distance of the developing unit necessary for one job, and the image area of the confidential information image 80.

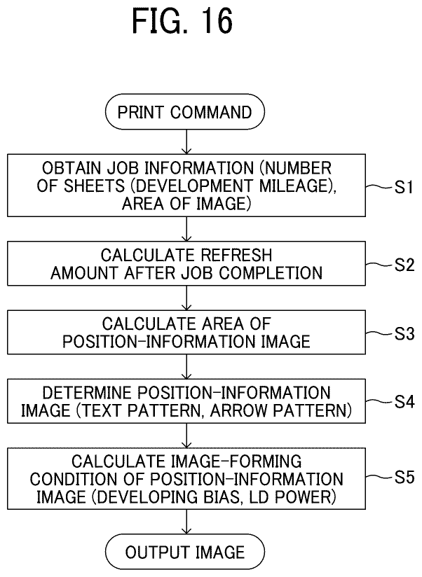

FIG. 16 is a flowchart of the setting of the position-information image 81, according to the present embodiment.

The first table given below illustrates an example setting of the position-information images 81 under the conditions as follows. In other words, the first table given below indicates conditions including a conditions that the refresh threshold is 25 cm²/m, a condition that the refresh threshold is 50 cm², a condition that the cumulative refresh amount before the job is 20 cm², and a condition that ten confidential information images having image areas of 3% (A4) are output.

First Table

| | | | | | IMAGE | |
|---|---|---|---|---|---|---|
| | | | | | AREA | AREA OF |
| | IMAGE | CUMULATIVE | | CUMULATIVE | WHERE | POSITION- |
| TRAVEL | AREA OF | REFRESH | REFRESH | REFRESH | CUMULATIVE | INFORMATION |
| DISTANCE OF | CONFIDENTIAL | AMOUNT | AMOUNT | AMOUNT | REFRESH | IMAGE |
| DEVELOPING | INFORMATION | BEFORE | TO BE | AFTER | AMOUNT | PER ONE |
| UNIT | IMAGE | JOB | ADDED | JOB | BECOME | SHEET |
| [m] | [cm²] | [cm²] | [cm²] | [cm²] | 0 [cm²] | [cm²] |
| 4 | 2 | 20 | 4 × 25 − | 20 + 80 = 100 | 100 | 100/10 = 10 |
| | | | (2 × 10) = 80 | | | |

Firstly, in a step S1, the controller 30 of the printer 200 acquires the number of sheets to be printed and the area of the confidential information image 80 as job information in response to the reception of a print command. As depicted in the first table according to the present embodiment, the number of sheets to be printed, i.e., ten sheets, and the area ratio of the confidential information image 80, i.e., 3% (A4) are acquired from the job information, and the area of the confidential information image i.e., 2 cm², is calculated from the acquired area ratio of the confidential information image 80, i.e., 3% (A4).

Subsequently, in a step S2, the controller 30 calculates the cumulative refresh amount after the end of the print job. More specifically, the controller 30 reads the cumulative refresh amount (in the example of the first table, the cumulative refresh amount: 20 cm²) stored in the memory of the apparatus.

Subsequently, a refresh amount to be added after the print job is calculated. The refresh amount to be added is a value obtained by subtracting the image area of the confidential information image 80 in the print job from a value calculated from the travel distance of the developing unit in the print job and the refresh threshold. The travel distance of the developing unit is calculated by multiplying the travel distance of the developing device per one sheet stored in advance in the memory by the number of sheets to be printed. The cumulative refresh amount after the end of the print job is calculated by adding the calculated refresh amount to be added to the cumulative refresh amount stored in the memory of the apparatus.

In the first table according to the present embodiment, the travel distance of the developing unit in the print job is 4 meters (m). The travel distance of the developing unit is calculated by multiplying the travel distance of the developing device per one sheet previously stored in the memory by the number of sheets to be printed. In the first table according to the present embodiment, the refresh threshold is 25 cm²/m, and the cumulative image size of the confidential information image 80 is 20 cm² (=2 cm²×10). Accordingly, in the first table according to the present embodiment, the refresh amount accumulated after the end of the print job is 80 cm² (=4 m×25 cm²/m−(2 cm²×10)). As the cumulative refresh amount before the print job is 20 cm², the cumulative refresh amount after the end of the print job is 100 cm² (=20 cm²⁺⁸⁰ cm²).

Subsequently, in a step S3, the controller 30 divides the calculated cumulative refresh amount after the print job by the number of sheets to be printed, and calculates the area of the position-information image per one sheet. In the first table according to the present embodiment, the image size per one sheet of the position-information image is 10 cm² (=100 cm^{2/10}). Setting the image size per one sheet of the position-information image to 10 cm² makes the cumulative refresh amount at the end of the print job become 0, and the IR toner in the developing device 9IR is refreshed.

Subsequently, in a step S4, the controller 30 determines a position-information image pattern closest to the calculated image area per one sheet from the multiple position-information image patterns stored in the memory in advance.

Subsequently, in a step S5, the controller 30 adjusts the image density of the determined position-information image. For example, when the image size of the position-information image pattern closest to the calculated image size per one sheet is 20 cm² and the calculated image size per one sheet of the position-information image is 10 cm², the image forming conditions (developing bias and LD power) are determined so that the image density is such that the amount of toner consumption is half.

In the above description, the controller 30 adjusts both the position-information image pattern and the image density based on the calculated image area per one sheet. However, no limitation is indicated thereby, and only the position-information image pattern may be adjusted or only the image density may be adjusted.

In the above description, the position-information image pattern is selected or the image density is adjusted such that the cumulative refresh amount after the end of the job will be 0. However, no limitation is indicated thereby, and it is satisfactory as long as the cumulative refresh amount after the end of the job is equal to or greater than 0 and less than the discharge execution threshold H. If the cumulative refresh amount after the end of the job becomes less than 0, not only the old IR toner in the developing device but also the new IR toner supplied to the developing device tend to be consumed. This is wasteful toner consumption, and is undesired. On the other hand, when the cumulative refresh amount after the end of the job is equal to or greater than the discharge execution threshold H, the refresh control is executed after the end of the job. This is undesired.

In the above description, the position-information image 81 and the confidential information image are formed of transparent IR toner. However, no limitation is indicated thereby, and the position-information image 81 and the confidential information image may be formed of visible toner.

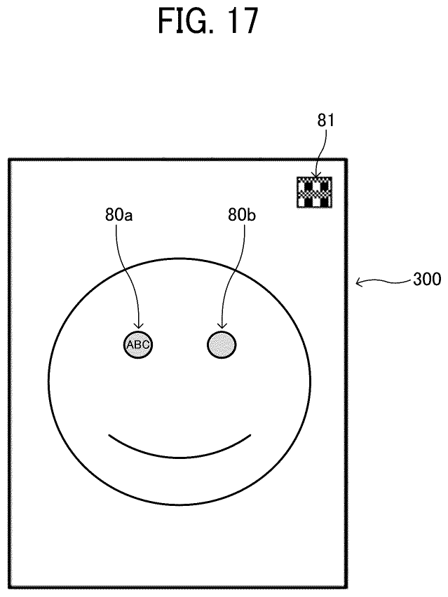

FIG. 17 is a diagram illustrating the printed material 300 in which the position-information image 81 and a pair of confidential information images 80a and 80b are formed with visible toner, according to the present embodiment.

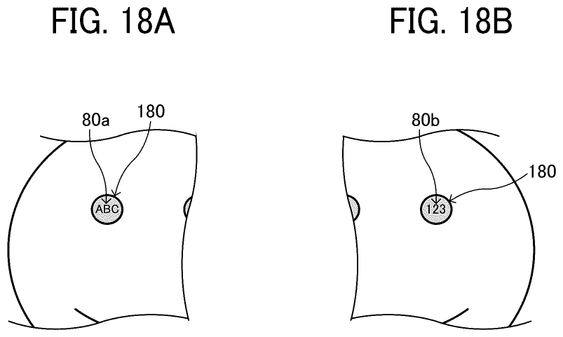

FIG. 18A is an enlarged view of the printed material 300 illustrated in FIG. 17 around the first confidential information image 80a, according to the present embodiment.

FIG. 18B is an enlarged view of the printed material 300 illustrated in FIG. 17 around the second confidential information image 80b, according to the present embodiment.

In FIG. 17, the position-information image 81 is a QR code formed with visible toner, and is formed on the top right. Each one of the confidential information images 80a and 80b is a latent image hidden by the background image 180.

The background image 180 is formed of visible toner that does not absorb any infrared light. The confidential information images 80a and 80b have the same color as the background image 180 under visible light and are formed of IR toner that absorbs infrared light. As these confidential information images 80a and 80b are captured with the infrared camera 90, the confidential information images 80a and 80b whose color reproduction is different from that of the background image 180 appear, and can be distinguished from the background image 180. Due to such a configuration, the confidential information can be acquired from the confidential information images 80a and 80b. In the present embodiment, confidential information “ABC” is obtained from the first confidential information image 80a, and confidential information “123” is obtained from the second confidential information image 80b.

In the embodiment as illustrated in FIG. 17, the confidential information image is divided into a plurality of images in consideration of design. However, no limitation is indicated thereby, and it is not necessary for the confidential information image to be divided as long as the design is not impaired. Depending on an image such as a latent image in which character strings are spaced apart from each other, the area of the background image 180 may be reduced by dispersing the confidential information image into a plurality of images. Such a configuration is preferable because the confidential information images are dispersed and toner consumption can be reduced.

As the image forming apparatus capable of printing the printed material 300 illustrated in FIG. 17, FIG. 18A, and FIG. 18B, the image forming apparatus illustrated in FIG. 13 can be used except that the IR toner on the 6IR of the processing unit is a colored IR toner. In such cases, as described above, the color K is formed by superimposing the Y color toner, the M color toner, and the C color toner on top of one another. When the IR toner is the K color, the background image 180 is formed by superimposing the Y color toner, the M color toner, and the C color toner on top of one another, and thus a large amount of toner is consumed in forming the background image 180 to hide the confidential information image 80. When the area of the background image 180 is wide, there is some concern that the durability of fixation deteriorates. Accordingly, when the confidential information image 80 is frequently used, it is desired that one of the Y color toner, the M color toner, and the C color toner may be used in place of the IR toner. Due to such a configuration, the background image can be formed only with any one of the Y color toner, the C color toner, and the M color toner. As a result, the toner consumption can be prevented, and the durability of fixation can be prevented from deteriorating.

On the other hand, as known in the art, the black toner includes carbon that absorbs infrared rays and can serve as an IR toner just as it is, and thus can form the confidential information image 80 using the configuration or structure of a known image forming apparatus. This provides a great advantage over the other kinds of toner. Accordingly, when the confidential information image 80 is rarely printed, it is desired that the confidential information image 80 be formed using the black toner even though there is a disadvantage that a large amount of toner is consumed to form the background image 180. Further, as will be described later, it is also possible to prevent the durability of fixation from deteriorating. An example in which the confidential information image is formed using black toner as known in the art will be described later in detail.

In FIG. 17, FIG. 18A, and FIG. 18B, the confidential information image is a character string, and this character string is confidential information. However, no limitation is indicated thereby, and in a similar manner to FIG. 1 to FIG. 12, the confidential information image may be a coded image such as a QR code, and confidential information may be included in such a coded image.

As the position-information image 81 including the QR code formed at the top right of FIG. 17 is captured with a camera, information such as the position information of the confidential information images, the number of confidential information images, and the order in which the confidential information images are to be read are read and obtained. The read information is displayed on, for example, an image display unit of the camera. Then, the camera is switched to the infrared mode, and the spot of the camera is moved to the position of the confidential information image based on the information displayed on an image display unit of the camera. As a result, the confidential information image is captured, and confidential information can be obtained.

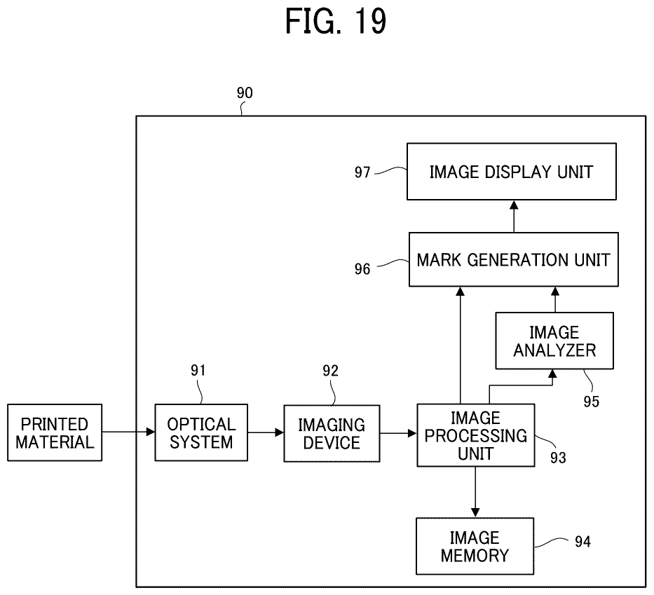

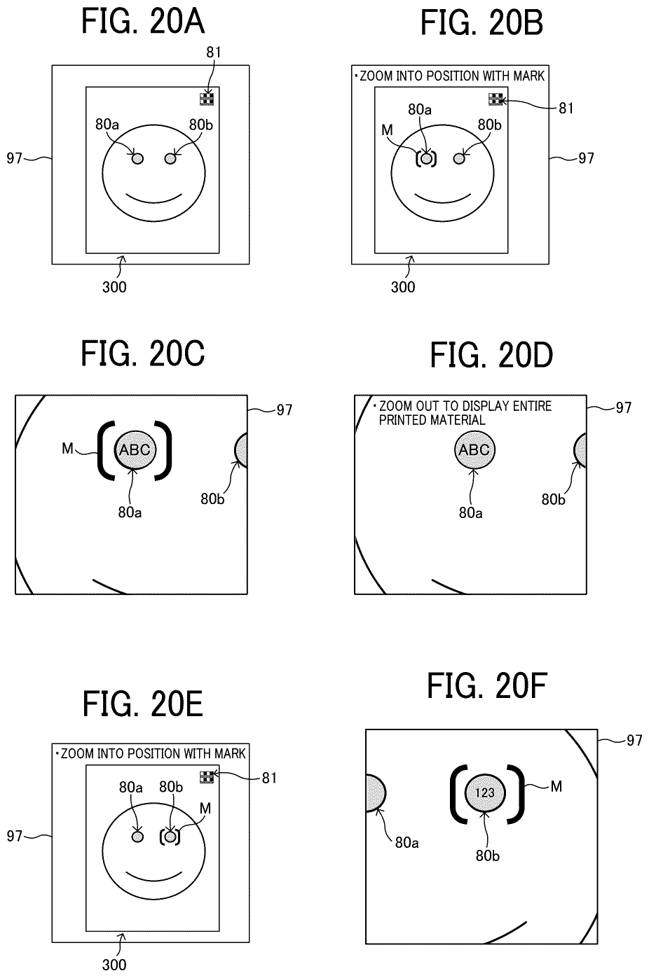

Alternatively, a focus mark may be displayed at a position corresponding to the confidential information image of the printed material 300 displayed on the image display unit of the camera 90 based on the position information acquired from the position-information image 81. Such an example will be described below with reference to FIG. 19 and FIG. 20A to FIG. 20F.

FIG. 19 is a functional block diagram for displaying a focus mark at a position corresponding to the confidential information image 80 on the printed material 300 displayed on an image display unit 97 of a camera 90, according to the present embodiment.

The camera 90 that serves as a data acquisition device includes, for example, an optical system 91, an imaging device 92, an image processing unit 93, an image memory 94, an image analyzer 95, a mark generation unit 96, and an image display unit 97.

The optical system 91 includes, for example, a focus lens and a shutter mechanism. The imaging device 92 includes an imager having sensitivity to visible light and an imager having sensitivity to infrared light, and the imager for imaging can be switched through, for example, the operation made by a user.

The image processing unit 93 performs image processing such as analog-to-digital (A/D) conversion and shading correction on an image captured by the imager. The image processed by the image processing unit 93 is transferred to the image display unit 97 and displayed on the image display unit 97 in real time. An image that is captured when the shutter release button of the camera is pressed is processed by the image processing unit 93. Then, the processed image is transferred to the image memory 94, and is stored in the image memory 94.

The image analyzer 95 analyzes the position-information image 81 and the confidential information image 80 to extract information. The image analyzer 95 extracts, for example, the position information of the confidential information images 80, the number of the confidential information images 80, and the order in which the confidential information images 80 are read, from the position-information image 81. In the present embodiment, the position information of the confidential information image 80 acquired from the position-information image 81 is the distance from the position-information image 81 to the confidential information image and the distance from the edge of the sheet to the confidential information image.

The mark generation unit 96 displays a focus mark at the position of the confidential information image of the captured image displayed in real time on the image display unit 97, based on the information extracted by the image analyzer 95, such as the position of the confidential information images 80, the number of the confidential information images 80, and the order in which the confidential information images 80 are read. For example, when the position information of the confidential information image 80 is the distance from the position-information image 81 to the confidential information image 80, the position of the position-information image 81 is specified by performing image analysis on an image obtained by capturing the entirety of the printed material 300. Then, the mark generation unit 96 displays the focus mark based on the distance from the position-information image 81 to the confidential information image 80. When the position information of the confidential information image 80 is the distance from the edge of the paper, the image obtained by photographing the entirety of the printed material 300 is analyzed to specify the edge position of the paper. Then, the mark generating unit 96 displays the focus mark based on the distance from the edge of the sheet. However, no limitation is intended thereby, and the focus mark may be displayed at the position of the confidential information image 80 based on the position information of the confidential information image 80 by another existing method. The image display unit 97 may be, for example, a liquid crystal panel and a touch panel that can display an image.

FIG. 20A to FIG. 20F are diagrams illustrating the transition of an image display unit 97 of a camera 90, according to the present embodiment.

The camera 90 has a confidential-information reading mode, and such a confidential information reading mode is executed when confidential information on the printed material 300 is to be read. Once the confidential information reading mode is executed, firstly, instructions to read the position-information image 81 are displayed on the image display unit 97.

The camera 90 is brought close to the position-information image 81 of the printed material 300 to capture the position-information image 81 having a sufficient size. Then, the image analyzer 95 recognizes the position-information image 81 formed of a quick response code, and the image analyzer 95 acquires information such as the position information of the confidential information image 80, the number of the confidential information images, and the order in which the confidential information images 80 are read, from the position-information image.

Once, for example, the position information of the confidential information images 80 is acquired from the position-information image 81, the camera 90 switches to the infrared mode and instructs a user to display the entirety of the printed material 300 on the image display unit 97.

As illustrated in FIG. 20A, once the entirety of the printed material 300 is displayed on the image display unit 97, the mark generation unit 96 displays a focus mark M at the first confidential information image 80a from which confidential information is firstly acquired as follows. In other words, as illustrated in FIG. 20B, the mark generation unit 96 displays the focus mark M at the first confidential information image 80a based on the captured image of the entirety of the printed material 300, the position information of the confidential information images, and the order in which the confidential information images are to be read.

The number of pixels of the first confidential information image 80a is small and the resolution is low in the image in which the entirety of the printed material 300 is displayed. For this reason, confidential information cannot be acquired from the first confidential information image 80a. Accordingly, as illustrated in FIG. 20B, the camera 90 displays on the image display unit 97 a message requesting to zoom into the first confidential information image 80a surrounded by the focus mark M.

Based on the instruction displayed on the image display unit 97, the camera is moved so that the focus mark M is positioned in the center of the screen while viewing the screen of the image display unit 97, zooming into the first confidential information image 80a. Then, as illustrated in FIG. 20C, once the first confidential information image 80a having a sufficient size is captured, the image analyzer 95 recognizes the first confidential information image 80a, i.e., the character string “ABC,”, and the confidential information “ABC” is acquired.

Once the confidential information is acquired from the first confidential information image 80a, as illustrated in FIG. 20D, the focus mark M disappears from the image display unit 97, and a message requesting to zoom out is displayed such that the entirety of the printed material 300 is displayed on the image display unit 97.

The camera 90 is moved based on the instruction displayed on the image display unit 97, and the entirety of the printed material 300 is displayed on the image display unit 97 again. Once the entirety of the printed material 300 is displayed on the image display unit 97, the mark generation unit 96 specifies the position of the second confidential information image 80b as follows. In other words, the position of the second confidential information image 80b is specified based on the image in which the entirety of the printed material 300 is displayed and the position information of the second confidential information image 80b such as the distance between the edge of the sheet and the second confidential information image 80b, and the distance between the position-information image and the second confidential information image 80b. Then, as illustrated in FIG. 20E, the camera 90 displays the focus mark M at the portion corresponding to the second confidential information image 80b.

In a similar manner to the first confidential information image 80a, the camera is moved so that the focus mark M is positioned in the center of the screen while viewing the screen of the image display unit 97, zooming into the second confidential information image 80b. Then, as illustrated in FIG. 20F, once the second confidential information image 80b having a sufficient size is captured, the image analyzer 95 recognizes the second confidential information image 80b, and the confidential information “123” is acquired.

As described above, once the confidential information is acquired from all the confidential information images printed on the printed material 300, the camera 90 displays the acquired confidential information on the image display unit 97. In the present embodiment, the confidential information “ABC123” is displayed on the image display unit 97.

As described above, the focus mark M is displayed at the portion corresponding to the confidential information image. As a result, the confidential information image can be prevented from being lost, and the confidential information image can easily be searched for. Moreover, the confidential information can be acquired in a prescribed order according to a message displayed on the image display unit 97 of the camera 90, and confidential information can be acquired correctly from the confidential information image that are divided into a plurality of pieces.

The camera 90 according to the present embodiment may be, for example, a smartphone provided with a camera. In such cases, the confidential information of the printed material 300 can be acquired using the application software installed in a smartphone with a camera, based on the method as described above.

If a zoom lens is provided for the camera, the camera may be configured to zoom into the confidential information image automatically, for example, when the focus mark is positioned in the center of the screen from a state as illustrated in FIG. 20B.

When the printed material 300 is small, the resolution of the camera 90 is high, and the resolution of the confidential information image and the position-information image is sufficiently high even from the image obtained by capturing the entirety of the printed material 300, the image analyzer 95 can recognize the confidential information image and the position-information image from the image obtained by capturing the entirety of the printed material 300. In such cases, the confidential information and the order in which the confidential information is to be obtained may be acquired at once from the image obtained by capturing the entirety of the printed material 300.

Alternatively, the scanner may acquire position information, and may acquire confidential information from the acquired position information. Further, the scanner may display the confidential information on the display unit of an external device such as the display unit of the scanner and a personal computer coupled to the scanner. More specifically, firstly, the scanner that serves as the data acquisition device reads the entirety of the printed material 300, and performs image analysis on the read image data to acquire the positions of the confidential information images and the order in which the confidential information images are arranged, from the position-information image formed of a QR code. Subsequently, the scanner specifies a plurality of confidential information images based on the position information of the acquired confidential information images, and performs image analysis on the specified confidential information images to acquire divided confidential information. Then, the scanner puts the divided confidential information into one based on the information on the order of the acquired confidential information, and displays the obtained confidential information on a display unit of the scanner or a display unit of an external device coupled to the scanner.

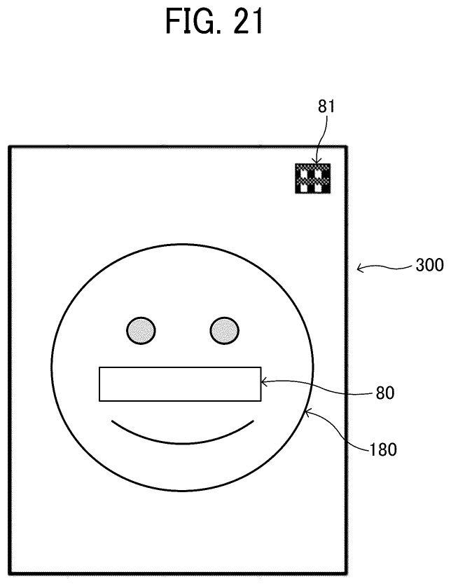

FIG. 21 is a diagram illustrating how the background image 180 conceals the confidential information image 80, according to an alternative embodiment of the present disclosure.

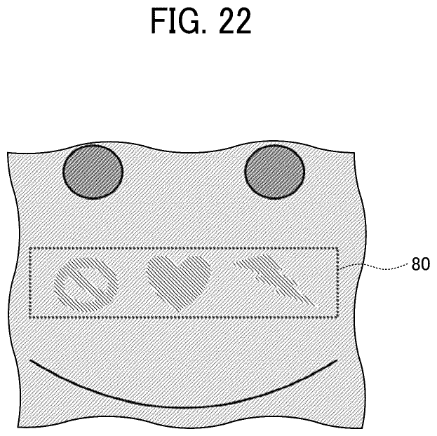

FIG. 22 is an enlarged view of the printed material 300 illustrated in FIG. 21, around the confidential information image 80, according to the present embodiment.

In the present embodiment as illustrated in FIG. 21 and FIG. 22, the background image 180 and the confidential information image 80 are formed of the same visible toner, but the dithering patterns of the background image 180 and the confidential information image 80 are made different from each other. It is difficult for the naked eyes to recognize this difference in dithering pattern, and the confidential information image 80 becomes a latent image of the background image 180, and the confidential information image 80 is concealed by the background image 180.

In the printed material 300 illustrated in FIG. 21 and FIG. 22, as the area around the confidential information image 80 is magnified for view with, for example, a magnifying glass, the difference in dithering pattern between the confidential information image 80 and the background image 180 can be distinguished, and the confidential information image 80 can be recognized. A camera can optically zoom into the area around the confidential information image 80 to capture the magnified image. By so doing, the difference in dithering pattern between the confidential information image 80 and the background image 180 can be distinguished and the confidential information image 80 can be recognized. A scanner increases the set resolution. By so doing, the difference in dithering pattern between the confidential information image 80 and the background image 180 can be distinguished, and the confidential information image 80 can be recognized.

Also in the printed material 300 as illustrated in FIG. 21 and FIG. 22, it is difficult to specify the position of the confidential information image with naked eyes, and thus the position-information image 81 is formed on the printed material 300. Due to such a configuration, the position of the confidential information image 80 can easily be easily found from the position information acquired from the position-information image 81, and the confidential information can be acquired from the confidential information image 80 by zooming in the found position and capturing the image around that position.

In the present embodiment as illustrated in FIG. 21 and FIG. 22, the position-information image 81 formed of the QR code may have resolution data in addition to the position information of the confidential information image. This is because if the resolution of the camera is low, there are some cases in which the dithering pattern of the confidential information image and the dithering pattern of the background image cannot be distinguished from each other in the captured image even if zooming in or out is performed to capture an image. In view of such circumstances, as the resolution data in the position-information image includes the resolution data, the camera can automatically change the resolution to high resolution based on the resolution data. Alternatively, the set resolution may be changed based on the resolution data displayed on the image display unit of the camera. As described above, as the set resolution of the camera is changed to high resolution, the image that is obtained by capturing the area around the confidential information image becomes a fine image, the dithering patterns of the confidential information image and the background image can satisfactorily be distinguished, and the confidential information image can be distinguished from the captured image.

When the confidential information is to be acquired by reading the printed material 300 as illustrated in FIG. 21 and FIG. 22 with a scanner, firstly, the position-information image including a QR code is read with the scanner, and the position of the confidential information image and the data of resolution to be set are acquired. Subsequently, the scanner changes the set resolution to high resolution based on the obtained resolution data. By so doing, the confidential information image 80 and the background image 180 can be read in a distinguishable manner.

Subsequently, the scanner reads the area around the formation position of the confidential information image of the printed material 300 with high resolution based on the position information of the confidential information image. As described above, only the area around the confidential information image is scanned. By so doing, the volume of image data can be reduced compared with cases in which the entirety of the printed material 300 is scanned at high resolution.

Then, the scanner displays the read image data on a display unit of the scanner or a display unit of an external device such as a PC. Due to such a configuration, the confidential information can be obtained from the image read by the scanner.

Alternatively, the confidential information image 80 may be specified by analyzing the read image data, and the image data may be processed so as to emphasize the confidential information image 80, and the processed data may be displayed on the display unit of the scanner or the display unit of an external device such as a PC. If the external device coupled to the scanner is the printer 200, the processed data may be printed out. According to such a configuration, the confidential information can easily be acquired from the image read by the scanner.

Alternatively, the confidential information may be acquired by analyzing the read image data and specifying the confidential information image 80, and the acquired confidential information may be displayed on the display unit of the scanner or the display unit of an external device such as a PC.

In the printed material 300 as illustrated in FIG. 21 and FIG. 22, information can be concealed without using special toner such as IR toner, and the printed material 300 as illustrated in FIG. 21 and FIG. 22 can be a generated using a general-purpose image forming apparatus. When information is concealed using IR toner, the concealed information cannot be acquired unless an image is captured by an apparatus including an imager having sensitivity to infrared light. By contrast, the concealed information can be acquired from the printed material 300 illustrated in FIG. 21 and FIG. 22 by a general-purpose scanner or camera that is provided with only an imager having sensitivity to visible light. If the set resolution of the scanner is increased, the printed material 300 as illustrated in FIG. 21 and FIG. 22 can be photocopied. If the set resolution of the scanner is decreased, the printed material 300 can be photocopied as a normal image from which any confidential information image is reproduced.

On the printed material 300 as illustrated in FIG. 21 and FIG. 22, a confidential information image can be formed using color toner of a plurality of colors, and the confidential information image 80 can be easily blended into a normal image. Accordingly, the confidential information image 80 can be made less outstanding than the printed material 300 as illustrated in FIG. 17, FIG. 18A, and FIG. 18B.

Also in the configurations as illustrated in FIG. 20A to FIG. 20F and FIG. 21, a plurality of confidential information images may be formed to divide the confidential information into a plurality of pieces. Alternatively, the confidential information image may be a code image such as a QR code, and confidential information may be included in such a coded image.

The printed material 300 on which the confidential information image 80 and the multiple position-information images 81 are formed with general-purpose black toner containing carbon that absorbs infrared radiation will be described below.

As described above, as known in the art, black toner is different from other kinds of color toner including yellow color toner, magenta color toner, and cyan color toner, in that the color toner contains carbon that absorbs infrared radiation, and can be read by an infrared camera. By making use of such characteristics, the confidential information image that is invisible under normal conditions but can be read by an infrared camera can be formed.

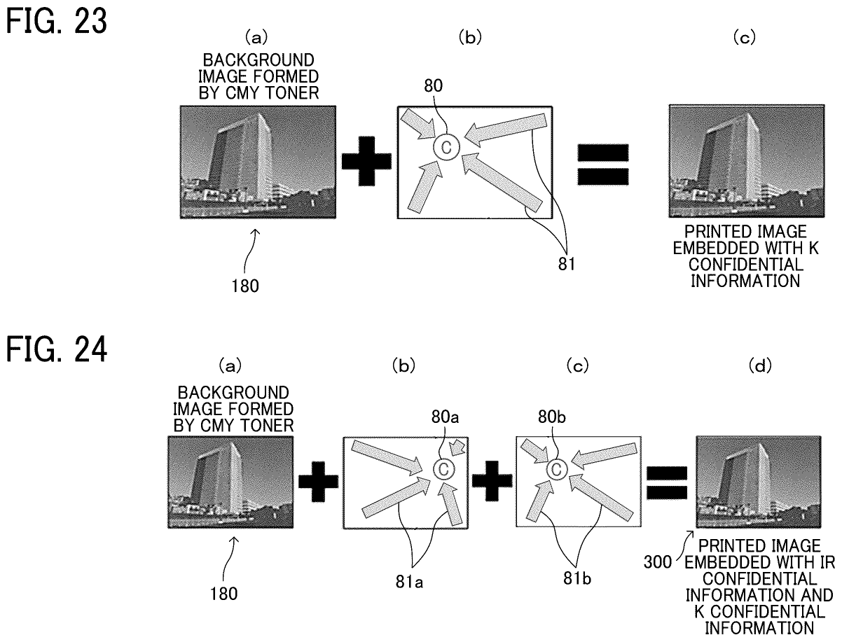

FIG. 23 consists of a plurality of diagrams (a) to (c) each illustrating the printed material 300 on which the confidential information image 80 and the multiple position-information images 81 are formed with general-purpose black toner, according to the present embodiment.

As illustrated in (b) of FIG. 23, the confidential information image 80 and the position-information image 81 that are formed of the black toner are black unlike images formed of IR toner. Accordingly, in order to make the confidential information image 80 and the position-information image 81 difficult to be visually recognized, it is preferable that the confidential information image 80 and the position-information image 81 are halftone images and are formed as thin images.

The confidential information image 80 and the position-information image 81 that are formed of black color toner as illustrated in the diagram (b) of FIG. 23 is covered with and hidden by a background image 180 formed with Y color toner, M color toner, and C color toner as illustrated in the diagram (a) of FIG. 23. Due to this configuration, as illustrated in FIG. 23C, the confidential information image 80 and the position-information image 81 that are formed of the black toner are hidden by the background image 180 formed of the Y color toner, the C color toner, and the M color toner, and the confidential information image 80 and the position-information image 81 turn to be images that cannot visually be recognized easily.

When the printed material 300 as illustrated in the diagrams (a) to (c) of FIG. 23 is captured using the infrared camera 90 that serves as the data acquisition device, the position-information images 81 that are formed of black toner containing carbon that absorbs infrared light is displayed on the image display unit of the infrared camera 90 and becomes visible. By moving the infrared camera along the arrow of the visible position-information image 81, the confidential information image 80 can be easily found and the confidential information can be read.

FIG. 24 consists of a plurality of diagrams (a) to (d) each illustrating the printed material 300 having the confidential information image 80a formed with IR toner or the confidential information image 80b formed with black toner, according to the present embodiment.

In the present embodiment, the first confidential information image 80a and the first position-information image 81a that together indicate the position of the first confidential information image 80a, as illustrated in (b) of FIG. 24, are formed of IR toner. Moreover, in the present embodiment, the second confidential information image 80b and the second position-information image 81b that indicates the position of the second confidential information image 80b, as illustrated in (c) of FIG. 24, are formed of black toner. The second confidential information image 80b and the second position-information image 81b that are formed of the black toner are covered with and hidden by the background image 180 formed of the Y color toner, the C color toner, and the M color toner, as illustrated in the diagram (a) of FIG. 24. As a result, the printed material 300 illustrated in the diagram (d) of FIG. 24 is obtained.

The IR toner absorbs infrared light of, for example, 800 nm, and the black toner absorbs infrared light of, for example, 950 nm. Accordingly, the wavelengths of the infrared light absorbed by the first confidential information image 80a and the first position-information image 81a, which are formed by the IR toner, can be made different from the wavelengths of the infrared light absorbed by the second confidential information image 80b and the second position-information image 81b, which are formed by the black toner.

As described above, the wavelengths for absorbing infrared light different between the first confidential information image 80a and the second confidential information image 80b are made different from each other. As a result, advantageous effects are achieved as follows. In other words, for example, the first confidential information image 80a that is formed by the IR toner that absorbs infrared light of 800 nm is favorably detected by a near-infrared camera using a complementary metal oxide semiconductor (CMOS) image sensor excellent in near-infrared detection of 780 to 900 nm. On the other hand, for example, the second confidential information image 80b that is formed of black toner that absorbs infrared light of 950 nm can be configured so as not to be detected by a near-infrared camera using a CMOS image sensor.

On the other hand, the second confidential information image 80b that is formed with the black toner is favorably detected by a near-infrared camera using an indium gallium arsenide (InGaAs) image sensor excellent in near-infrared detection of 900 to 1700 nm. However, the first confidential information image 80a that is formed by the IR toner cannot be favorably detected by a near-infrared camera using an InGaAs image sensor.

As described above, as long as a plurality of infrared cameras having mutually different infrared detection wavelength ranges are not used, all the confidential information that is formed on the printed material 300 cannot be obtained. This is advantageous because the security level can be increased, and such a configuration can hardly be imitated.

The printed material 300 as illustrated in the diagrams (a) to (d) of FIG. 24 includes a first position-information image 81a formed of IR toner and a second position-information image 81b formed of black toner. Accordingly, when the printed material is imaged by the near-infrared camera using the CMOS image sensor, the first position-information image 81a is captured, and the position of the first confidential information image 80a can be easily figured out based on the first confidential information image 80a. When the printed material is imaged by a near-infrared camera using an InGaAs image sensor, the second position-information image 81b is projected, and the position of the second confidential information image 80b can be easily figured out based on the second position-information image 81b.

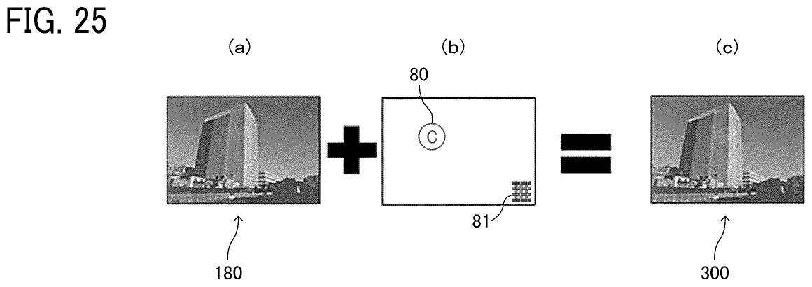

FIG. 25 consists of a plurality of diagrams (a) to (c) illustrating the printed materials 300 illustrated in the diagrams of (a) to (c) of FIG. 23, respectively, where the position-information images 81 are converted into a coded image, according to the present embodiment.

As illustrated in the drawings (a) to (c) of FIG. 25, the position-information image 81 may be a QR code in a similar manner to the position-information image 81 as illustrated in FIG. 17, FIG. 18A, and FIG. 18B. For example, when the confidential information image 80 is searched for by automation, the position-information image 81 that includes a QR code is arranged at the scan starting point of the infrared camera. In the present embodiment as illustrated in the drawings (a) to (c) of FIG. 25, the position-information image 81 is arranged at the bottom right. Accordingly, the machine first reads the QR code, which is the position-information image, with the infrared camera, and receives the position information of the confidential information image. Then, the infrared camera is moved based on the received position information of the confidential information image to capture the confidential information image. As a result, the confidential information image can be quickly read.

A method of forming the confidential information image 80 and the position-information images with general-purpose black toner as illustrated in the drawing (a) of FIG. 23 to the drawing (d) of FIG. 25 is described below.

As the image forming apparatus that forms the confidential information image and the position-information images with general-purpose black toner, for example, the processing unit 6IR that uses IR toner in the image forming apparatus as illustrated in FIG. 13 may be replaced with a processing unit that uses black toner K.

As illustrated in the diagrams (a) to (d) of FIG. 24, when the printed material on which the confidential information image made of the IR toner and the confidential information image made of the black toner are printed is to be formed, the processing units for the Y color toner, the M color toner, the C color toner, and the K color toner, and the IR toner are arranged as follows. The processing units are arranged in the order of Y, M, C, K, and IR. Alternatively, the processing units are arranged in the order of Y, M, C, IR, and K in the moving direction on the surface of the intermediate transfer belt.

The image forming apparatus as illustrated in FIG. 13 can also generate the printed material illustrated in the drawings (a) to (d) of FIG. 24. More specifically, the IR processing unit and the toner bottle are replaced with a processing unit and a toner bottle for K color. Then, the processing unit for K color is used to form the confidential information image and the position-information image made of black toner on the sheet of paper P. Subsequently, the processing unit and the toner bottle for K color are replaced with the processing unit and the toner bottle for IR. Then, the confidential information image and the IR toner, the position-information image, and the background image 180 made of the Y color toner, the M color toner, and the C color toner are formed on the sheet of paper P on which the confidential information image made of the black toner and the position-information image are formed. Due to such a configuration, the printed material illustrated in the drawings (a) to (d) of FIG. 24 can be formed.

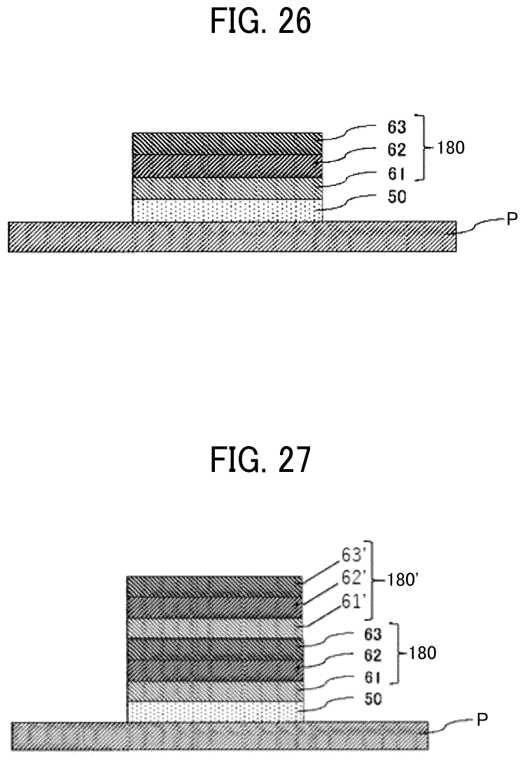

FIG. 26 is a schematic diagram illustrating a background image 60 of Y color toner, M color toner, and C color toner is formed on a black toner image, according to the present embodiment.

As the processing unit for the K color toner is arranged downstream from the processing units for the Y color toner, the M color toner, and the C color toner in the moving direction of the intermediate transfer belt, the toner image of the color K is primarily transferred onto the toner images of the Y color toner, the M color toner, and the C color toner on the intermediate transfer belt. As described above, as the K toner image is superimposed on the toner images of the Y color toner, the M color toner, and the C color toner on the intermediate transfer belt, as illustrated in FIG. 26, a K toner image 50 becomes a lower layer than a C toner image 61, a M toner image 62, and a Y toner image 63 that together form the background image 180 on the sheet of paper P. Accordingly, the confidential information image 80 and the position-information image that are formed of the K toner are covered with and hidden by the background image 180 formed with the Y color toner, the M color toner, and the C color toner, and the confidential information image 80 and the position-information image that are formed of the K toner can be made difficult to be visually recognized.

It is satisfactory as long as the K toner image is formed below the toner images of the Y color toner, the M color toner, and the C color toner on the sheet, no limitation is intended to the configuration in which the K color processing unit is disposed downstream from the processing units for the Y color toner, the M color toner, and the C color toner in the moving direction of the intermediate transfer belt. When the direct transfer type image forming apparatus in which the toner image of each processing unit is directly transferred to the sheet, the processing unit for K toner is disposed upstream from the processing units for the Y color toner, the M color toner, and the C color toner in the conveyance direction of the sheet of paper P. Accordingly, the K toner image can be formed below the toner images of the Y color toner, the M color toner, and the C color toner on the sheet, and the confidential information image 80 and the position-information image formed by the K toner can be covered with and hidden by the background image 180 formed by the Y color toner, the M color toner, and the C color toner.

FIG. 27 is a schematic diagram illustrating a plurality of background images 180 of Y color toner, M color toner, and C color toner are formed on a black toner image, according to the present embodiment.

As the confidential information image 80 and the position-information image 81 formed with the K toner are colored, the confidential information image 80 and the position-information image 81 that is formed with the K toner may be visible depending on the background image to be formed. Accordingly, as illustrated in FIG. 27, the background image 180 may be thickened by forming the background image 180 composed of the Y color toner, the M color toner, and the C color toner a plurality of times.

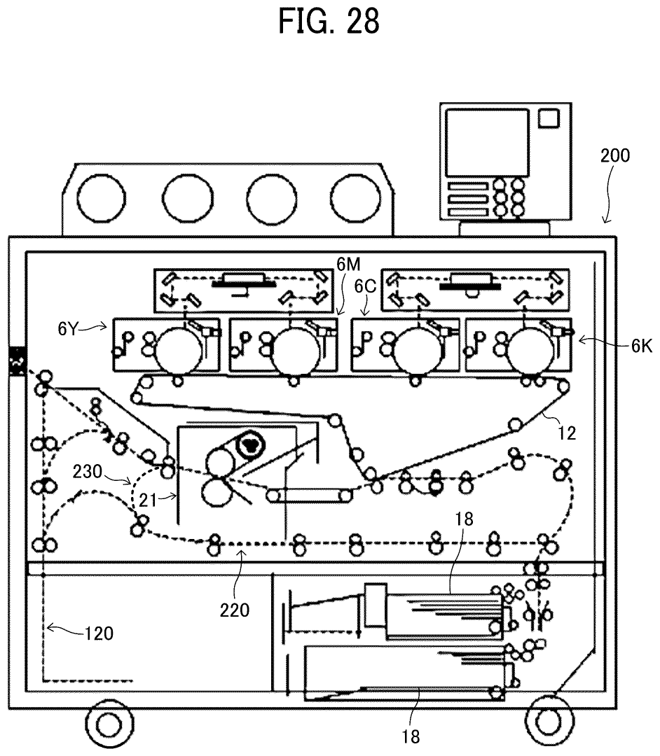

FIG. 28 is a diagram illustrating an image forming apparatus provided with a re-conveyance path 220, according to the present embodiment.

When the background image is formed a plurality of times, it is desired that the image forming apparatus provided with a re-conveyance path 220 be used as illustrated in FIG. 28. The image forming apparatus as illustrated in FIG. 28 includes a relay path 230 that conveys the sheet of paper P having passed through the fixing device 21 to the re-conveyance path 220 without passing through a switchback path 210.

The confidential information image 80 and the position-information image 81 that are formed of black toner and the first background image 180 that is formed of the Y color toner, the M color toner, and the C color toner are transferred onto the front surface of the sheet of paper P fed from the sheet tray 18, and then the sheet of paper P is fixed by the fixing device 21. Subsequently, the sheet of paper P on the front surface of which the confidential information image 80, the position-information image 81, and the first background image 180 are fixed is transported to the re-conveyance path 220 via the relay path 230. In such a configuration, as the sheet of paper P is conveyed to the re-conveyance path 220 without being switched back in the switchback path 210, the sheet of paper P is conveyed again to the secondary transfer position as the image forming position without being turned inside out.

Then, the second background image 180′ formed of the Y color toner, the M color toner, and the C color toner is transferred onto the first background image 180 on the front surface of the sheet re-conveyed to the secondary transfer nip, and then is fixed to the sheet of paper P by the fixing device 21.

With the use of the image forming apparatus as illustrated in FIG. 28, the printed material including the confidential information image and the position-information image made of black toner and the background image 180 made of the Y color toner, the M color toner, and the C color toner can be formed in a plurality of batches. More specifically, in the first batch, the black toner image and the Y toner image are transferred onto the front surface of the sheet, and the black toner image and the Y toner image are fixed onto the sheet. In the second batch, the M toner image and the C toner image are transferred onto the front surface of the sheet, and the M toner image and the C toner image are fixed onto the sheet. In this manner, the printed material including the confidential information image and the position-information image formed of black toner and the background image 180 formed of the Y color toner, the M color toner, and the C color toner may be formed. As the printed material is formed in this manner, the durability of fixation can be prevented from deteriorating even if the background image 180 is wide.

In the method where a plurality of images are transferred onto the front surface of the sheet in a plurality of batches, the processing unit 6K that uses K color toner can form the K toner on the lowermost layer of the sheet even if the K color is not disposed most downstream in the moving direction of the intermediate transfer belt.

Moreover, the method of forming an image on the front surface of the sheet in a plurality of batches is not limited to a configuration in which the confidential information image and the position-information image are formed of black toner, but may also be applied to a configuration in which the confidential information image and the position-information image are formed of invisible toner such as IR toner. Moreover, as the fixing process is divided into a plurality of batches as described above, fixing can be performed without causing fixation failure.

In the embodiment as described above, the printed material 300 is formed of toner. However, no limitation is indicated thereby, and the printed material 300 that includes, for example, the confidential information image 80 and the position-information image 81 may be printed using color ink of Y color, M color, and C color and IR ink in an ink-jet image forming apparatus. Alternatively, the printed material 300 that includes, for example, the confidential information image 80 and the position-information image 81 may be printed with black ink containing carbon and having infrared light absorption characteristics.

An information transmission system 600 that includes and uses the printer 200, the printed material 300, and the infrared camera 90 as described above is described below.

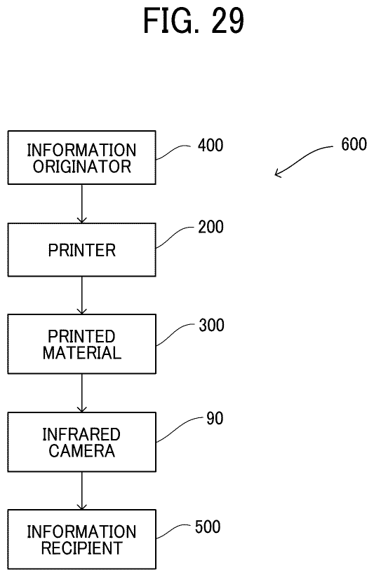

FIG. 29 is a functional block diagram of the information transmission system 600 according to the present embodiment.

Firstly, an information originator 400 who provides confidential information outputs an image having confidential information generated using a personal computer or the like through, for example, the printer 200 as illustrated in FIG. 13 or FIG. 28 to generate the printed material 300 as illustrated in FIG. 1, FIG. 4 to FIG. 12B, FIG. 17, FIG. 21, and the drawing (a) of FIG. 23 to the drawing (c) of FIG. 25. An information recipient 500 who receives the confidential information obtains such confidential information using the infrared camera 90 as described above. Due to such a configuration, the confidential information is passed to the information recipient 500. As the information sender provides the printed material 300 on which the position-information image 81 as illustrated in, for example, FIG. 1, FIG. 4 to FIG. 12B, FIG. 17, FIG. 21, and the drawing (a) of FIG. 23 to the drawing (c) of FIG. 25 is printed, the information recipient 500 can easily acquire the confidential information. Further, with the use of the infrared camera 90 as described above with reference to, for example, FIG. 19, the information recipient 500 can more easily acquire the confidential information.

The embodiments described above are given as an example, and unique advantageous effects are achieved for each of the following modes given below.

First Mode

The confidential information image 80 visible under a special condition is printed on the printed material 300 according to a first mode of the present disclosure, and the printed material 300 includes an information image such as the position-information image 81 related to the position of the confidential information image 80.

According to the present mode, the position of the confidential information image 80 can be easily found from the information image such as the position-information image related to the position of the confidential information image 80 printed on the printed material 300.

Second Mode

In the printed material 300 according to the first mode of the present disclosure, the confidential information image 80 is made of a special-light responsive image forming material such as IR toner.

Due to such a configuration, as described above in the embodiments of the present disclosure, it is difficult to visually recognize the confidential information image except under special conditions such as irradiation with special light such as infrared light and imaging with a special camera such as an infrared camera, and the confidential information image 80 can be concealed as desired.

Third Mode

In the printed material 300 according to the second mode of the present disclosure, the special-light responsive image forming material may be infrared absorbing toner such as IR toner or infrared absorbing ink such as IR ink.

According to the present mode, it is difficult to visually recognize the confidential information image 80 except under special conditions such as imaging with a special camera such as an infrared camera, and the confidential information image 80 can be concealed as desired.

Fourth Mode

In the printed material 300 according to the first mode of the present disclosure, the confidential information image is a latent image distinguishable from a background image visible under visible light, under a special condition.

Due to such a configuration, as described above with reference to FIG. 17, FIG. 18A, FIG. 18B, and FIG. 21 to FIG. 25C, it is difficult to visually recognize the confidential information image 80 as the confidential information image 80 is blended into the background image 180 except under special conditions such as a condition that imaging is performed with an infrared camera and a condition that the resolution of the camera is increased. As a result, the confidential information image 80 can be concealed as desired.

Fifth Mode

In the printed material 300 according to the fourth mode of the present disclosure, the confidential information image 80 is made of a special-light responsive image forming material such as IR toner whose color is equivalent to the color of the background image 180 under visible light.

Due to such a configuration, as described above with reference to FIG. 17, FIG. 18A, and FIG. 18B, it is difficult to visually recognize the confidential information image 80 as the confidential information image 80 is blended into the background image 180 and becomes a latent image except under special conditions such as irradiation with special light such as infrared light and imaging with a special camera such as an infrared camera. As a result, the confidential information image 80 can be concealed as desired.

Sixth Mode

In the printed material 300 according to the fourth mode of the present disclosure, the background image 180 has a dithering pattern different from the dithering pattern of the confidential information image 80.

Due to such a configuration, as described above with reference to FIG. 21 and FIG. 22, it is difficult to visually recognize the confidential information image 80 as the confidential information image 80 is blended into the background image 180 and becomes a latent image except under special conditions such as magnification of an area around the confidential information image 80 with a camera or the like. As a result, the confidential information image 80 can be concealed as desired.

Seventh Mode

In the printed material 300 according to the first mode or fourth mode of the present disclosure, the confidential information image 80 is formed of black toner or black ink, and the second confidential information image 80 is covered with a background image formed of an image forming material such as Y color toner, M color toner, and C color toner in the present embodiment visible under visible light, other than black toner and black ink.

Due to such a configuration, as described above with reference to FIG. 23A to FIG. 25C, the confidential information image 80 that is formed of black toner or black ink can be concealed as covered with the background image 180. Moreover, as the confidential information image 80 that is formed of the black toner or the black ink absorbs infrared rays, the confidential information image 80 can be visually recognized under a special condition in which an image is captured by an infrared camera.

Eighth Mode

The printed material 300 according to the second mode or third mode of the present disclosure further comprises a second confidential information image formed of black toner or black ink, and at least the second confidential information image is covered with a background image formed of an image forming material such as Y color toner, M color toner, and C color toner in the present embodiment visible under visible light, other than black toner and black ink.

Due to such a configuration, as described above with reference to FIG. 24A to FIG. 24D, the confidential information image composed of the special-light responsive image forming material and the second confidential information image can be made visible under special conditions different from each other, and the security of the confidential information image formed on the printed material can be enhanced.

Ninth Mode

In the printed material 300 according to the eighth mode of the present disclosure, a special condition under which the second confidential information image becomes visible is different from a special condition under which the confidential information image made of a transparent special-light responsive image forming material becomes visible.

Due to such a configuration, as described above with reference to FIG. 24A to FIG. 24D, the security of the confidential information image formed on the printed material can be enhanced.

Tenth Mode

In the printed material 300 according to the ninth mode of the present disclosure, the transparent special-light responsive image forming material is infrared absorbing toner such as IR toner or infrared absorbing ink, and a peak wavelength of infrared radiation absorbed by at least one of the infrared absorbing toner and the infrared absorbing ink is different from a peak wavelength of infrared radiation absorbed by the black toner or the black ink.

Due to such a configuration, as described above with reference to FIG. 24A to FIG. 24D, as long as a plurality of infrared cameras having mutually different infrared detection wavelength ranges are not used, all the confidential information that is formed on the printed material 300 cannot be obtained. This is advantageous because the security level can be increased.

Eleventh Mode

In the printed material 300 according to any one of the seventh mode to tenth mode of the present disclosure, at least one of the black toner and the black ink includes carbon.

Due to such a configuration, as described above with reference to FIG. 23A to FIG. 25C, the confidential information image 80 that is formed of the black toner or the black ink absorbs infrared rays, and the confidential information image 80 can be visually recognized under a special condition in which an image is captured by an infrared camera.

Twelfth Mode

In the printed material 300 according to any one of the first mode to eleventh mode of the present disclosure, the information image such as the position-information image 81 is an invisible image visible under a condition that the confidential information image is visible.

According to the present mode, as described above in the embodiments of the present disclosure, the information image such as the position-information image 81 becomes a latent image and cannot be visually recognized except under a special condition. For this reason, the image that is formed on the printed material 300 is not impaired by the position-information image. Moreover, when the confidential information image is searched for by means that makes the confidential information image visible, such as an infrared camera, the information image such as the position-information image 81 becomes visible, and the position information of the confidential information image can be acquired from the information image. As a result, the confidential information image 80 can easily be searched for.

Thirteenth Mode

In the printed material 300 according to the twelfth mode of the present disclosure, the information image such as the position-information image 81 has an arrow image that indicates the position of the confidential information image.

Due to such a configuration, as described above with reference to, for example, FIG. 4, the position of the confidential information image can be figured out from the direction indicated by the arrow images, and the confidential information image can be found out.

Fourteenth Mode

In the printed material 300 according to the twelfth mode or thirteenth mode of the present disclosure, the information image such as the position-information image 81 has a textual image indicating the position of the confidential information image.

Due to such a configuration, as described above with reference to FIG. 1 and FIG. 11, the position of the confidential information image can be figured out from the textual image, and the confidential information image can be found out.

Fifteenth Mode

In the printed material 300 according to any one of the tenth mode to fourteenth mode of the present disclosure, an information image such as the position-information image 81 is printed radially from the confidential information image.

Due to such a configuration, as described above with reference to, for example, FIG. 5 to FIG. 8, the position of the confidential information image can be figured out from the density of an image such as the position-information image 81, and the confidential information image can be found out.

Sixteenth Mode

In the printed material 300 according to any one of the eleventh mode to fifteenth mode of the present disclosure, the information image such as the position-information image 81 is a gray scale image whose image density changes as the distance from the confidential information image increases.

Due to such a configuration, as described above with reference to FIG. 8 to FIG. 10, the position of the confidential information image can be figured out from the changes in levels of gradation in the density of the position-information image 81, and the confidential information image can be found out.

Seventeenth Mode

In the printed material 300 according to any one of the first mode to sixteenth mode of the present disclosure, the information image such as the position-information image 81 is a code image from which information about a position of the confidential information image is read by a reading device.

Due to such a configuration, as described above with reference to, for example, FIG. 17, FIG. 21, FIG. 25A, FIG. 25B, and FIG. 25C, as the code image read or scanned, information such as the position information of the confidential information images, the number of the confidential information images, and order in which the confidential information images are to be read can be acquired. Moreover, compared with a configuration in which a textual image is adopted, the above information can be carried by a small image, and even if the position-information image is an image visible under visible light, the design of the position-information image is not impaired.

Eighteenth Aspect

In the printed material 300 according to any one of the first mode to seventeenth mode of the present disclosure, the confidential information image includes a plurality of confidential information images, and an information image such as the information image indicates at least one of a number of the multiple confidential information images and an order in which the plurality of confidential information images are read.

Due to such a configuration, as described above with reference to FIG. 5 to FIG. 9 and FIG. 17, having the information about the number of confidential information images can prevent the confidential information images from being left unread and not acquired. Moreover, having the information about the order in which the confidential information images are to be read allows the confidential information to be acquired from the confidential information image in the correct order.

Nineteenth Mode

On the printed material 300 according to the nineteenth mode of the present disclosure, a plurality of confidential information images visible under special conditions are printed. Moreover, the printed material 300 according to the nineteenth mode of the present disclosure includes an information image configured to indicate at least one of a number of the plurality of confidential information images and an order in which the plurality of confidential information images are read.

Due to such a configuration, as described above with reference to, for example, FIG. 12A and FIG. 12B, having the information about the number of confidential information images can prevent the confidential information images from being left unread and not acquired. Moreover, having the information about the order in which the confidential information images are to be read allows the confidential information to be acquired from the confidential information image in the correct order.

Twentieth Mode

An image forming apparatus according to the twentieth mode of the present disclosure forms an image on a recording medium to form the printed material 300, and can generate the printed material 300 according to any one of the first mode to nineteenth mode of the present disclosure.

Twenty-First Mode

In the image forming apparatus according to the twentieth mode of the present disclosure, the information image such as the position-information image 81 is automatically stored in a recording medium when the confidential information image is to be formed.

According to the present mode, the trouble of generating an information image such as the position-information image 81 can be reduced by, for example, application software.

Twenty-Second Mode

The image forming apparatus according to the twenty-first mode of the present disclosure includes a calculator configured to calculate the amount of image forming material that needs to be discharged from the developing device, in order to replace an old image forming material such as toner in the developing device with a new image forming material, and the information image such as the position-information image 81 is formed, based on the amount of image forming material that needs to be discharged such as the cumulative refresh amount, which is calculated by the calculator.

Due to such a configuration, as described above in the embodiments of the present disclosure, the amount of image forming material to be disposed of can be reduced.

Twenty-Third Mode

In the image forming apparatus according to the twenty-second mode of the present disclosure, the information image such as the position-information image 81 is changed, according to the amount of the image forming material that needs to be discharged, which is calculated by a calculator.

According to the present mode, as described above in the embodiments of the present disclosure, when the amount of the image forming material that needs to be discharged such as the cumulative refresh amount is large, the information image such as the position-information image 81 that requires a large amount of image forming material can be chosen, and the image forming material such as the toner that needs to be discharged from the developing device can be effectively used. On the other hand, when the amount of the image forming material that needs to be discharged is small, the information image that requires a relatively small amount of image forming material can be chosen, and the consumption of the image forming material that does not need to be discharged can be controlled.

Twenty-Fourth Mode

In the image forming apparatus according to the twenty-second mode or twenty-third mode of the present disclosure, the image density of the information image such as the position-information image 81 is changed, according to the amount of image forming material that needs to be discharged such as the cumulative refresh amount, which is calculated by a calculator.

According to the present mode, as described above in the embodiments of the present disclosure, when the amount of the image forming material which needs to be discharged such as the cumulative refresh amount is large, the image density is increased so that a large amount of the image forming material can be used and the image forming material such as the toner which needs to be discharged from the developing device can be effectively used. On the other hand, when the amount of the image forming material that needs to be discharged is small, the image density may be reduced to prevent the image forming material that does not need to be discharged from being consumed.

Twenty-Fifth Mode

In the image forming apparatus according to the twenty-fourth mode of the present disclosure, at least one of the radiation intensity of light exposure of the exposure device 11 that exposes a latent-image bearer such as the photoconductor 7 to form a latent image and the developing bias of the developing device 9 is adjusted to change the image density.

Due to such a configuration, as described above in the embodiments of the present disclosure, the amount of image forming material such as toner adhering to the latent-image bearer such as the photoconductor 7 can be adjusted, and the image density of the information image such as the position-information image 81 is changed.

Twenty-Sixth Mode

In the image forming apparatus according to any one of the twenty-second mode to twenty-fifth mode of the present disclosure, a position-information image is formed such that the amount of image forming material that needs to be discharged from a developing device, e.g., a cumulative refresh amount after forming an image including an information image such as the position-information image 81 is equal to or greater than 0 and less than an execution threshold such as a discharge execution threshold H used to execute refresh control to discharge old image forming material in the developing device.

Due to such a configuration, as described above in the embodiments of the present disclosure, refresh control is executed after image formation, and an image forming material such as waste toner can be prevented from being generated. Moreover, the image forming material that does not need to be discharged can be prevented from being consumed.

Twenty-Seventh Mode

The image forming apparatus according to any one of the twentieth mode to twenty-sixth mode of the present disclosure further includes a re-conveyance path 220 configured to re-convey a recording medium that has passed through an image forming position such as a secondary transfer position at which an image is formed on a recording medium such as a sheet of paper P to the image forming position, and the recording medium is passed through the image forming position a plurality of times to form an image on the recording medium in a plurality of batches. As a result, a printed material is generated.

Due to such a configuration, as described above with reference to FIG. 28, the background image 180 can be made thick, or the occurrence of fixation failure can be controlled.

Twenty-Eighth Mode

A data acquisition device such as the infrared camera 90 acquires confidential information from the confidential information image on the printed material 300 according to any one of the first mode to nineteenth mode of the present disclosure. The data acquisition device according to any one of the first mode to nineteenth mode of the present disclosure includes a specification unit such as the image analyzer 95 configured to specify a position of the confidential information image from the information image such as the position-information image 81, and a display unit such as the image display unit 97 configured to display position information of image confidential information image specified by the specification unit.

Due to such a configuration, as described above in the embodiments of the present disclosure, the confidential information image can be found based on the position information displayed on the display unit such as the image display unit 97 of the data acquisition device such as the infrared camera 90.

Twenty-Ninth Mode

In the data acquisition device according to the twenty-eighth mode of the present disclosure, the display unit such as the image display unit 97 displays the printed material 300 captured by an imager, and adds a mark such as the focus mark M to a position corresponding to the confidential information image of the printed material 300 displayed on the display unit based on the position information of the confidential information image specified by the specifying unit such as the image analyzer 95.

Due to such a configuration, as described above in the embodiments of the present disclosure, the location of the confidential information image on the printed material 300 can be figured out based on the mark such as the focus mark M displayed on the display unit, and the confidential information image can easily be found.

Thirtieth Mode

In the data acquisition device according to the twenty-ninth mode of the present disclosure, when a plurality of confidential information images are formed on the printed material 300 and an information image such as the position-information image 81 includes information about the order at which the multiple confidential information images are acquired, the confidential information image to be marked is changed based on the information about the order in which the position-information images are acquired and whether confidential information is acquired from the confidential information image with a mark.

Due to such a configuration, as described above in the embodiments of the present disclosure, the confidential information can be acquired from the confidential information images in the correct order.

Thirty-First Mode

An information transmission system according to the thirty-first mode of the present disclosure outputs a printed material 300 on which a confidential information image is printed using an image forming apparatus such as a printer 200, and uses an data acquisition device such as an infrared camera 90 to acquire the confidential information from the confidential information image. As a result, the confidential information is transmitted. In the information transmission system according to the thirty-first mode of the present disclosure, at least one of the printed material according to any one of the first mode to nineteenth mode of the present disclosure, the image forming apparatus according to any one of the twentieth mode to twenty-seventh mode of the present disclosure, and the data acquisition device according to any one of the twenty-eighth mode to thirtieth mode of the present disclosure is used.

Due to such a configuration, as described above with reference to FIG. 29, the information recipient 500 can easily acquire the confidential information.

Note that numerous additional modifications and variations are possible in light of the above teachings. It is therefore to be understood that within the scope of the appended claims, the disclosure of the present disclosure may be practiced otherwise than as specifically described herein. For example, elements and/or features of different illustrative embodiments may be combined with each other and/or substituted for each other within the scope of this disclosure and appended claims.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An image forming apparatus comprising;
an image former to form an image on a recording medium to form a printed material,
the printed material comprising:
a confidential information image visible under a special condition; and
an information image having information on a position of the confidential information image,
wherein the information image is invisible under visible light, and
the information image comprises a plurality of information images, which has function to lead toward the confidential information image,
wherein the image former comprising:
a first image former to form a background image which is different from the confidential information image and the information image, and
a second image former including special toner or special ink to form the information image.

2. The image forming apparatus according to claim 1,
wherein the first image former includes a yellow process cartridge, a cyan process cartridge, and a magenta process cartridge.

3. The image forming apparatus according to claim 1,
wherein the confidential information image is made of a transparent special-light responsive image forming material.

4. The image forming apparatus according to claim 3,
wherein the special-light responsive image forming material is infrared absorbing toner or infrared absorbing ink.

5. The image forming apparatus according to claim 1,
wherein the confidential information image is a latent image distinguishable from the background image, which is visible under visible light, under the special condition.

6. The image forming apparatus according to claim 5,
wherein the confidential information image is made of a special-light responsive image forming material whose color is equivalent to a color of the background image under visible light.

7. The image forming apparatus according to claim 2,
wherein the second image former includes a special process cartridge including infrared absorbing toner or infrared absorbing ink.

8. The image forming apparatus according to claim 1,
wherein the confidential information image is formed of black toner or black ink, and
wherein the confidential information image is covered with a background image formed of an image forming material visible under visible light, other than the black toner and the black ink.

9. The image forming apparatus according to claim 8, wherein the printed material further comprises:
a second confidential information image formed of black toner or black ink,
wherein at least the second confidential information image is covered with a background image formed of an image forming material visible under visible light, other than the black toner and the black ink.

10. The image forming apparatus according to claim 9,
wherein a special condition under which the second confidential information image becomes visible is different from the special condition under which the confidential information image made of a transparent special-light responsive image forming material becomes visible.

11. The image forming apparatus according to claim 10,
wherein the transparent special-light responsive image forming material is infrared absorbing toner or infrared absorbing ink, and
wherein a peak wavelength of infrared radiation absorbed by at least one of the infrared absorbing toner or the infrared absorbing ink is different from a peak wavelength of infrared radiation absorbed by the black toner or the black ink.

12. The image forming apparatus according to claim 8,
wherein at least one of the black toner or the black ink includes carbon.

13. The image forming apparatus according to claim 1,
wherein the information image is a latent image visible under a condition that the confidential information image is visible.

14. An image forming apparatus comprising;
an image former to form an image on a recording medium to form a printed material,
the printed material comprising:
a confidential information image visible under a special condition;
an information image having information on a position of the confidential information image; and
a background image,
wherein the information image comprises a plurality of information images, which has function to lead toward the confidential information image, and
wherein the image former is configured to form a first dithering pattern on the background image which is different from a second dithering pattern formed on the confidential information image.
